(19) United States
(12) Patent Application Publication
(10) Pub. No.: US 2011/0208852 A1
(43) Pub. Date: Aug. 25, 2011

(54) Regionally-Tiered Internet Banner Delivery and Platform for Transaction Fulfillment of E-Commerce

(76) Inventors: Erin C. Looney, Reno, NV (US); Scott C. Armstrong, Reno, NV (US)

(21) Appl. No.: 13/035,817

(22) Filed: Feb. 25, 2011

Related U.S. Application Data
(60) Provisional application No. 61/308,225, filed on Feb. 25, 2010.
(60) Provisional application No. 61/411,446, filed on Nov. 8, 2010.

(51) Int. Cl. G06F 15/173

(52) U.S. Cl. 709/223

(57) ABSTRACT

Regionally-tiered Internet banner delivery may be provided. A banner presentation portion configured to present banners may be provided for presentation to a user via a screen of a client computing platform. Banners associated with sponsors may be received. Individual ones banners may be configured to present media content. Two or more tiers may be defined, which include a first tier and a second tier. Individual ones of the tiers may correspond to different overlapped and/or non-overlapped geographical areas. The first tier may correspond to a larger geographical area than the second tier. A given banner may be associated with a given tier based on a desired geographical area to which the given banner is directed. Individual ones of the banners may be provided, based on a location of the user, for presentation to the user via the presentation portion of the screen of the client computing device.

### CROSS-REFERENCE TO RELATED APPLICATIONS

The present application claims the priority benefit of U.S. provisional patent application Ser. No. 61/308,225 filed Feb. 25, 2010 and entitled “System and Method for Facilitating Transactions Over Mobile Platforms,” and U.S. provisional patent application Ser. No. 61/411,446 filed Nov. 8, 2010 and entitled “System and Method for Facilitating Transactions Over Mobile Platforms,” the disclosures of both are incorporated herein by reference.

### FIELD OF THE DISCLOSURE

This disclosure relates to regionally-tiered internet banner delivery, and more specifically to an internet protocol-based banner interactive marketing system, which utilizes regionally-tiered banner delivery and/or algorithmic filtering of processed user identity and preference data and location-based information.

### BACKGROUND

Currently, a remarkably small percentage of all businesses sponsor banner advertisement. This small percentage still touches a market so large, that it provides enough scope for a business such as Google to become a $160B corporation. Nevertheless, it still suggests room for innovative improvement in the still emerging domain of internet protocol based marketing, sponsorship, and advertisement.

### SUMMARY

According to one or more implementations, the invention may be directed to an Internet protocol-based banner interactive marketing system (“IPBBIM”), which utilizes regionally-tiered banner delivery and algorithmic (“intelligent”) filtering of processed user identity and preference data and location-based information. The system may optionally interface into a new model of user experience for “interactive promotion” with prospective customers, as described herein below.

The following describes some of the features of a system constructed in accordance with the invention, which may be formed independently or combined with another system, such as the Dibbs Platform. The Dibbs platform may be at least partially described herein, but for purposes of describing the features below, the Dibbs platform generally relates to an interactive media system which may include any or all of the following services: social networking, interactive media platforms, gaming/entertainment and awareness, notification and procurement capabilities based on updated user tracked preferences, such as those described herein.

One or more features of the system below may be able to be natively hosted on a single platform, such as The Dibbs Platform, or licensed as a service seamlessly provided by the proprietary platform to third party websites, mobile applications, and platforms who are able to utilize and incorporate the features into their own platform. The features are “served” to third parties from a service platform, such that it is transparent to end users that various functions and features were outsourced. In other words, an Internet Protocol Based Banner Interactive Marketing Service (or services) can be launched in a similar manner to Google's AdSense, or Apple's iAd, for intelligent, location-based delivery of banners to any other platform that wishes to benefit from such features and revenue opportunities.

Tiered banner delivery may address problems with targeting a sponsor to exact regions where the sponsor's potential customers will be located. Banners no longer appear on websites completely agnostic of the location of their users, or even, aware of the location of the user but not utilizing an algorithmic method that properly categorizes and dispenses banners with intelligently organized levels of multiply tiered regional targeting.

According to some implementations, regional tiering may be suitable for national sponsors who may wish a way to saturate certain subnational geographic zones (such as “blue states”, or “bible belt regions”, or “the coasts”, or “urban areas”, or “rural areas”), exclude other areas and use the savings to more highly saturate targeted areas, etc. Regional tiering may be suitable for local sponsors may wish to advertise on national platforms but not pay national rates, because their banner ads only appear for users in specific localities, regardless of the platform being national.

For national platforms or platforms that service a plurality of regions, local sponsors may wish a finer, more intelligent way to specify the tier or scope of the banner delivery. In some implementations, the Dibbs platform may provide two or more tiers, that is, the Dibbs platform may include a tier that targets every user of the platform, a tier that targets a very specific locality, and a tier that either considers a smaller geographical or jurisdictional area or considers alternative cross-sections of users. For example, a platform that serves the West Coast may offer the entire West Coast for one price structure, or individual counties (such as Marin County) for the lesser tiered price structure. Without the Dibbs platform and/or the system described herein, a sponsor that wants to target with more or less specificity (such as, Sausalito, or all or Northern California) does not have a structure/mechanism for specifying the desired target accurately.

It is noteworthy that the concepts discussed herein with respect to regional tiering are not intended to be limiting. For example, these concepts may be applied, in some implementations, for banner tiering that includes a temporal dimension. More specifically, time, like space, is another dimension by which banner tiering may be implemented. A banner sponsor may wish to target days of the week, times of day, or other blocks of time, which are believed to be better targeted to the sponsor's audience. As such, blocks of time can be treated as “temporal regions.”

Regional tiering divides the world into scopes or tiers. The higher tiers subsume smaller tiers which in turn subsume smaller tiers below them. Higher tiers may command a premium price point for sponsorship. In accordance with some implementations, the regional tier structure may be broken down into one or more of global tier, a continental tier, a national tier, a subnational tier, a regional tier, a metropolitan tier, a city tier, a neighborhood tier, a GPS radial tier, and/or other tiers.

Regional tiering may provide for the ability for fully redundant overlapping. For example, Florida can be included in a region of East Coast states, but also in the region of Southern States. Tiers have “Tier Division Schemata”. Each division schema exclusively divides a tier so that there is no overlap between peers within the schema. For example, “Northern California”, “Central California”, and “Southern California” would not overlap when peers within the same tier division schema. However, sponsors have the ability to choose from a number of division schemata within a tier. Within a different division schema, California may be divided as “Coastal”, “Central Valley”, and “Sierra”. Obviously, “Coastal California” would overlap all the different regions of Northern, Central, and Southern California from a different tier division schema. Letting sponsors choose tier division schemata allows them to even better target specific audiences. The meticulousness of there being no overlap within any given tier division schema allows for clean accounting of a number of different business issues such as, for example, avoiding banner redundancy due to overlap.

In some implementations, regional and other banner tiering may be coupled with banner inventory-pricing algorithms. Such coupling may facilitate optimally filling tiers and/or times based on supply/demand, market dynamics, pricing formulas, and/or other factors. By way of non-limiting example, unmoved inventory in one tier may temporarily adjust downward in price, or the amount of inventory in that tier may be lessened to create more inventory in a tier that is experiencing greater market demand and pricing.

Regional tiering may allow for free market supply/demand to naturally gravitate to the exact price point that fills the “queue” of available ads for a tier. Thus, if the demand for the lowest level tier in a given city, the GPS Radial Tier, settles the price at $5/month, then numerous bagel shops and boutique stores suddenly sponsor banner ads, that never dreamed of it before. Each tier above that lowest tier commands a wider area and a higher price point, but the higher price point is “baker's dozen” discounted such that it still represents a discount in cost per impressions over the tier below it, so that, starting from the smallest brick and mortar business all the way up to national and global sponsors, everyone has a tier and price point that appeals to them for internet protocol based banner interactive marketing.

Pricing for tiers and specific regions within a tier, may be based on [quasi]-free market price fluctuation based on real supply and demand metrics, in order that a tier's banner queue will always be filled with sponsor banners. By way of non-limiting example and for the purpose of illustration, a national banner queue may have 28 spots for sale. These 28 spots may go at a premium because there are only so many spots to fill. With Regional Tiered Banner Deliver, there could be 4 spots at the national level, 4 at the subnational, 4 at the regional, 4 at the metropolitan, 4 at the city, 4 at the neighborhood, and 4 at the GPS radial. However, the national tier may be composed of 6 subnational regions, allowing for the sale of 24 sponsorships into the 4 slots (at a lower cost). Nevertheless, according to the “baker's dozen economics”, the 24 subnational sponsorships at the lower cost still net more than 4 national sponsorships at the national tier pricing. Each of the subnational regions may have, for example, 6 slots at the regional tier. This means 144 slots for regional tier, which, by the “baker's dozen economics”, net more than the 24 subnational slots, which in turn net more than the 4 national slots. Continuing with this example and arbitrarily picking an average of 6 smaller regions within a greater region, the metropolitan tier has 864 slots to replace 4 of the slots in our typical national example. The city tier would have 5,184 slots to replace 4 of the national slots in our status quo example. The neighborhood tier would have 31,104 slots to replace 4 of the national slots in our status quo example, and the GPS radial tier would have 186,624 slots to replace 4 of the slots in the status quo example. With seven tiers each replacing 4 slots, the national example has 7*4=28 slots for sale as stated. The regionally tiered example, on the other hand, has 4+24+144+864+5184+31104+186624=223,948 slots for sale. Regardless of the fact that the pricing is much lower in the lower tiers, the sheer volume combined with “baker's dozen economics” creating higher price-per-impression in the lower tiers, nets dramatically more revenue than previous models with limited or no regional tiering. Addition of additional tiering approaches (e.g., temporal tiering) may further multiply the slots available in the non-temporally tiered example given above.

Delivery of banners to individual users may fit a double queued model. Each tier has a queue of banners within it. A tier can be thought of as a Pez Dispenser, and each banner can be thought of as a Pez candy. Each time the service calls for a banner from a certain tier, it pops the next banner out of the queue. Once a banner is “popped” and displayed, it re-enters the queue at the end of the queue. Thus, there is a continuous loop of banners made available for display. This cycling of banners may be referred to as a cyclical sequence. So that every banner is equal and “fairly placed” within the queue, the beginning of the queue is randomly determined each time a user begins using the service. Alternatively, those who pay a higher premium or bid higher to get banners in a certain tier, will be accordingly prioritized earlier in the queue; or, those who bought out remaining slots in the queue at a discount just so remaining slots were sold, are accordingly prioritized toward the end of the queue; or, alternative mechanisms involving bidding/pricing and queue prioritizing, can be structured at a later date. Alternatively, more banner ads may be purchased by an advertiser so that more are available for display in the queue.

While each tier has a queue of banners, tiers themselves have to cycle through turns. Each tier must have an opportunity to display/deliver its banners, and thus, tiers must cycle through a queue as well. Hence the term “queue of queues”. So, while tiers have queues of banners within them, there is also a queue of tiers. For example, the queue of tiers may be sequenced thus: national queue, subnational queue, regional queue, metropolitan queue, etc. Sequentially, one or more of the following actions may occur in the cycle, in accordance with one or more implementations: (1) a tier is selected from the queue of tiers; (2) from the selected tier, a banner is delivered from that tier's queue; (3) the displayed banner goes to the end of the queue within the tier; (4) from the queue of tiers, the next tier is selected; (5) from the next tier's queue, the next banner comes out of that tier's queue; (6) the displayed banner goes to the back of its tier's queue; (7) from the queue of tiers, the next tier is selected; and so on

If this top level queue of tiers were a simple queue, then it would be accurate to call the banner delivery system a “queue of queues”. However, the top level queue may optionally have algorithmic assistance via a processor to ensure more intelligent cycling at the tier level. This is based on the fact that some tiers may have more banner slots filled than other tiers. In a simple example of a pure queue of queues, take a queue of two tiers where one tier has a queue of 10 banner slots filled, but the tier below it has only 1 banner slot filled. In this case, the one banner in the lower tier would be displayed every other time, while each banner in the tier above would be displayed only once every 20 times. In an example with algorithmic assistance, the tier with 10 banners may be multiply-queued within the queue of tiers, present 10 times for every one time the tier with 1 banner is present, resulting in a proportionate delivery of the banner inventory. Algorithmic assistance is not limited to the above, but may include other approaches for activating banner inventory with proportionality, or by some other criterion to select and activate banner inventory.

An algorithm may be applied to more intelligently select which tier comes up next, weighing certain factors. Such factors may include the actual “turn” a tier has in the cycle. Alternatively and similarly, the factors may include the period of time which has passed since that queue has been displayed. The factors may include the number of filled banner slots in the tier's queue there are, relative to the number of filled banner slots in other tiers that have been filled. The factors may include the prioritization of one queue over another economically: business decisions that have made the company decide to feature one queue more than another based on a particular tier receiving bids or pricing that result in that tier getting a higher price-per-impression, and/or market demand being higher for a certain tier than another, etc.

One or more aspects of the disclosure relate to a system configured to provide regionally-tiered internet banner delivery, in accordance with one or more implementations. The system may implement one or more features described herein. For example, the system may include one or more features associated with the Dibbs platform and/or other features. The system may include at least one client computing platform, at least one sponsor server, one or more external resources, at least one banner delivery server, and/or other components, all being communicatively coupled to a network.

The network may include the Internet and/or other networks. It will be appreciated that this is not intended to be limiting, and that the scope of this disclosure includes implementations in which the client computing platform, the sponsor server, the external resources, the banner delivery server, and/or other components are operatively linked via some other communication media.

The client computing platform may include one or more processors configured to execute computer program modules. The computer program modules may be configured to enable one or more users associated with the client computing platform to interface with the system, the sponsor server, the external resources, the banner delivery server, and/or other components, and/or provide other functionality attributed herein to the client computing platform. By way of non-limiting example, the client computing platform may include one or more of a desktop computer, a laptop computer, a handheld computer, a NetBook, a Smartphone, and/or other computing platforms. As such, the client computing platform may include one or more user interface devices. Examples of such user interface devices include a screen, a touch pad, a touch screen, a keyboard, a keypad, and/or other user interface devices suitable to facilitate interactions and/or information transfer between the client computing platform and a user.

The sponsor server may be configured to provide one or more banners. A given banner may be associated with a given sponsor. Individual ones of the one or more banners may be configured to present media content. Media content may include still images, video, audio, and/or other media content. Individual ones of the one or more banners may be associated with other features described herein. The sponsor server may include one or more processors configured to execute computer program modules, electronic storage, and/or other components.

The external resources may include sources of information, hosts and/or providers of web sites and/or services outside of the system, external entities participating with the system, and/or other resources. In some implementations, the external resources may include social networking web sites, content providers, and/or other resources. Some or all of the functionality attributed herein to the external resources may be provided by resources included in the system.

The banner delivery server may be configured to provide regionally-tiered internet banner delivery. The banner delivery server may include electronic storage, at least one processor, and/or other components.

The electronic storage may comprise electronic storage media that electronically stores information. The electronic storage media of the electronic storage may include one or both of system storage that is provided integrally (i.e., substantially non-removable) with the banner delivery server and/or removable storage that is removably connectable to the banner delivery server via, for example, a port (e.g., a USB port, a firewire port, etc.) or a drive (e.g., a disk drive, etc.). The electronic storage may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage may store software algorithms, information determined by processor, information received from the client computing platform, the sponsor server, the external resources, information associated with features described herein, and/or other information that enables the banner delivery server to function as described herein.

The processor(s) may be configured to provide information processing capabilities in the banner delivery server. As such, the processor may include one or more of a digital processor, an analog processor, a digital circuit designed to process information, an analog circuit designed to process information, a state machine, and/or other mechanisms for electronically processing information. The processor may be configured to execute one or more computer program modules and/or instructions. The processor may be configured to execute the computer program modules and/or instructions by software; hardware; firmware; some combination of software, hardware, and/or firmware; and/or other mechanisms for configuring processing capabilities on the processor. The computer program modules and/or instructions may be executed to cause the processor to perform methods and/or effectuate features described herein.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured to provide regionally-tiered internet banner delivery, in accordance with one or more implementations.

FIG. 2 is a flowchart illustrating a method for providing regionally-tiered internet banner delivery, in accordance with one or more implementations.

### DETAILED DESCRIPTION

According to one or more implementations, the invention may be directed to an internet protocol-based banner interactive marketing system (“IPBBIM”), which utilizes regionally-tiered banner delivery and algorithmic (“intelligent”) filtering of processed user identity and preference data and location-based information. The system may optionally interface into a new model of user experience for “interactive promotion” with prospective customers, as described herein below.

The following describes some of the features of a system constructed in accordance with the invention, which may be formed independently or combined with another system, such as the Dibbs Platform. The Dibbs platform may be at least partially described herein, but for purposes of describing the features below, the Dibbs platform generally relates to an interactive media system which may include any or all of the following services: social networking, interactive media platforms, gaming/entertainment and awareness, notification and procurement capabilities based on updated user tracked preferences, such as those described herein.

One or more features of the system below may be able to be natively hosted on a single platform, such as The Dibbs Platform, or licensed as a service seamlessly provided by the proprietary platform to third party websites, mobile applications, and other platforms who are able to utilize and incorporate the features into their own platform. The features are “served” to third parties from a service platform, such that it is transparent to end users that various functions and features were outsourced. In other words, an Internet Protocol Based Banner Interactive Marketing Service (or services) can be launched in a similar manner to Google's AdSense, or Apple's iAd, for intelligent, location-based delivery of banners to any other platform that wishes to benefit from such features and revenue opportunities. According to some implementations, third party platforms submit digital requests for content from/via web services or other protocols, then the appropriate content is served to the third party platform via the service platform.

Tiered banner delivery may address problems with targeting a sponsor to exact regions where the sponsor's potential customers will be located. Banners no longer appear on websites completely agnostic of the location of their users, or even, aware of the location of the user but not utilizing an algorithmic method that properly categorizes and dispenses banners with intelligently organized levels of multiply tiered regional targeting, temporal targeting, and/or user taste and/or user demographic profiling.

According to some implementation, regional tiering may be suitable for national sponsors who may wish a way to saturate certain subnational geographic zones (such as “blue states”, or “bible belt regions”, or “the coasts”, or “urban areas”, or “rural areas”), exclude other areas and use the saving to more highly saturate targeted areas, etc. Regional tiering may be suitable for local sponsors may wish to advertise on national platforms but not pay national rates, because their banner ads only appear for users in specific localities, regardless of the platform being national.

For national platforms or platforms that service a plurality of regions, local sponsors may wish a finer, more intelligent way to specify the tier or scope of the banner delivery. In some implementations, the Dibbs platform may provide two or more tiers, that is, the Dibbs platform may include a tier that targets every user of the platform, a tier that targets a very specific locality, and a tier that either considers a smaller geographical or jurisdictional area or considers alternative cross-sections of users. For example, a platform that serves the West Coast may offer the entire West Coast for one price structure, or individual counties (such as Marin County) for the lesser tiered price structure. Without the Dibbs platform and/or the system described herein, a sponsor that wants to target with more or less specificity (such as, Sausalito, or all or Northern California) does not have a structure/mechanism for specifying the desired target accurately.

Regional tiering divides the world into scopes or tiers. The higher tiers subsume smaller tiers which in turn subsume smaller tiers below them. Higher tiers may command a premium price point for sponsorship. In accordance with some implementations, the regional tier structure may be broken down into one or more of global tier, a continental tier, a national tier, a subnational tier, a regional tier, a metropolitan tier, a city tier, a neighborhood tier, a GPS radial tier, and/or other tiers. In a global tier, no user of the system, no matter where on the planet, will ever be excluded from the viewing of a banner ad that has been positioned on the global tier. In a continental tier, banners are targeted to any location within a specific continent, but not to any location outside that continent. In a national tier, banners are targeted to any location within a specific nation. In some instances, the national tier could be permitted to observe cultural boundaries or practical boundaries instead of political/national boundaries (such as Luxembourg and Belgium being clustered as one, Monaco and France, Andorra and Spain, San Marino and Italy, the American/British Virgin Islands, etc.) In is noteworthy that the ability for this kind of exception-making may be built into the system and may equally apply to one or more other tiers, e.g., the city tier may have Minneapolis/St.Paul, etc. In a subnational tier, banners are targeted to any location within a “subnational geographic zone”, such as West Coast, Midwest, Southeast, New England, etc. In a regional tier, a subnational tier is divided into regional tiers. For instance, “West Coast” gets divided into regions such as “Sierra Nevada”, “Pacific Northwest”, “Northern California”, etc. A metropolitan tier may include the urban area around a city, regardless of the manmade political boundaries of city, county, and so on. A city tier may be defined by the boundaries of a city. A neighborhood tier may include a neighborhood or section of a city. A GPS radial tier may represent a region within the radius of a specific pinpointed location. In a city, for example, it may be on the order of 3 blocks. In a sprawled area like rural Alaska or Texas, perhaps 6 miles. The actual radius setting is stored by geographic location in a database, based on publicly available population density data. The pinpointed location is the actual GPS location of a sponsor's brick and mortar business address. Users within the specified radius of the actual business receive ads.

Regional tiering may provide for the ability for fully redundant overlapping. For example, Florida can be included in a region of East Coast states, but also in the region of Southern States. Tiers have “Tier Division Schemata”. Each division schema exclusively divides a tier so that there is no overlap between peers within the schema. For example, “Northern California”, “Central California”, and “Southern California” would not overlap when peers within the same tier division schema. However, sponsors have the ability to choose from a number of division schemata within a tier. Within a different division schema, California may be divided as “Coastal”, “Central Valley”, and “Sierra”. Obviously, “Coastal California” would overlap all the different regions of Northern, Central, and Southern California from a different tier division schema. Letting sponsors choose tier division schema allows them to even better target specific audiences. The meticulousness of there being no overlap within any given tier division schema allows for clean accounting of a number of different business issues such as, for example, avoiding banner redundancy due to overlap.

Regional tiering may allow for free market supply/demand to naturally gravitate to the exact price point that fills the “queue” of available ads for a tier. Thus, if the demand for the lowest level tier in a given city, the GPS Radial Tier, settles the price at $5/month, then numerous bagel shops and boutique stores suddenly sponsor banner ads, that never dreamed of it before. Each tier above that lowest tier commands a wider area and a higher price point, but the higher price point is “baker's dozen” discounted such that it still represents a discount in cost per impressions over the tier below it, so that, starting from the smallest brick and mortar business all the way up to national and global sponsors, everyone has a tier and price point that appeals to them for internet protocol based banner interactive marketing.

Pricing for tiers and specific regions within a tier, may be based on [quasi]-free market price fluctuation based on real supply and demand metrics, in order that a tier's banner queue will always be filled with sponsor banners. By way of non-limiting example and for the purpose of illustration, a national banner queue may have 28 spots for sale. These 28 spots may go at a premium because there are only so many spots to fill. With Regional Tiered Banner Deliver, there could be 4 spots at the national level, 4 at the subnational, 4 at the regional, 4 at the metropolitan, 4 at the city, 4 at the neighborhood, and 4 at the GPS radial. However, the national tier may be composed of 6 subnational regions, allowing for the sale of 24 sponsorships into the 4 slots (at a lower cost). Nevertheless, according to the “baker's dozen economics”, the 24 subnational sponsorships at the lower cost still net more than 4 national sponsorships at the national tier pricing. Each of the subnational regions may have, for example, 6 slots at the regional tier. This means 144 slots for regional tier, which, by the “baker's dozen economics”, net more than the 24 subnational slots, which in turn net more than the 4 national slots. Continuing with this example and arbitrarily picking an average of 6 smaller regions within a greater region, the metropolitan tier has 864 slots to replace 4 of the slots in our typical national example. The city tier would have 5,184 slots to replace 4 of the national slots in our status quo example. The neighborhood tier would have 31,104 slots to replace 4 of the national slots in our status quo example, and the GPS radial tier would have 186,624 slots to replace 4 of the slots in the status quo example. With seven tiers each replacing 4 slots, the national example has 7*4=28 slots for sale as stated. The regionally tiered example, on the other hand, has 4+24+144+864+5184+31104+186624=223,948 slots for sale. Regardless of the fact that the pricing is much lower in the lower tiers, the sheer volume combined with “baker's dozen economics” creating higher price-per-impression in the lower tiers, nets dramatically more revenue than previous models with limited or no regional tiering.

Delivery of banners to individual users may fit a double queued model. Each tier has a queue of banners within it. A tier can be thought of as a Pez Dispenser, and each banner can be thought of as a Pez candy. Each time the service calls for a banner from a certain tier, it pops the next banner out of the queue. Once a banner is “popped” and displayed, it re-enters the queue at the end of the queue. Thus, there is a continuous loop of banners made available for display. This cycling of banners may be referred to as a cyclical sequence. So that every banner is equal and “fairly placed” within the queue, the beginning of the queue is randomly determined each time a user begins using the service. Alternatively, those who pay a higher premium or bid higher to get banners in a certain tier, will be accordingly prioritized earlier in the queue; or, those who bought out remaining slots in the queue at a discount just so remaining slots were sold, are accordingly prioritized toward the end of the queue; or, alternative mechanisms involving bidding/pricing and queue prioritizing, can be structured at a later date. Alternatively, more banner ads may be purchased by an advertiser so that more are available for display in the queue.

While each tier has a queue of banners, tiers themselves have to cycle through turns. Each tier must have an opportunity to display/deliver its banners, and thus, tiers must cycle through a queue as well. Hence the term “queue of queues”. So, while tiers have queues of banners within them, there is also a queue of tiers. For example, the queue of tiers may be sequenced thus: national queue, subnational queue, regional queue, metropolitan queue, etc. Sequentially, one or more of the following actions may occur in the cycle, in accordance with one or more implementations: (1) a tier is selected from the queue of tiers; (2) from the selected tier, a banner is delivered from that tier's queue; (3) the displayed banner goes to the end of the queue within the tier; (4) from the queue of tiers, the next tier is selected; (5) from the next tier's queue, the next banner comes out of that tier's queue; (6) the displayed banner goes to the back of its tier's queue; (7) from the queue of tiers, the next tier is selected; and so on

If this top level queue of tiers were a simple queue, then it would be accurate to call the banner delivery system a “queue of queues”. However, the top level queue may optionally have algorithmic assistance via a processor to ensure more intelligent cycling at the tier level. This is based on the fact that some tiers may have more banner slots filled than other tiers. In a simple example of a queue of two tiers where one tier has a queue of 10 banner slots filled, but the tier below it has only 1 banner slot filled, the one banner in the lower tier would be displayed every other time, while each banner in the tier above would be displayed only once every 20 times.

An algorithm may be applied to more intelligently select which tier comes up next, weighing certain factors. Such factors may include the actual “turn” a tier has in the cycle. Alternatively and similarly, the factors may include the period of time which has passed since that queue has been displayed. The factors may include the number of filled banner slots in the tier's queue there are, relative to the number of filled banner slots in other tiers that have been filled. The factors may include the prioritization of one queue over another economically: business decisions that have made the company decide to feature one queue more than another based on a particular tier receiving a bids or pricing that result in that tier getting a higher price-per-impression, and/or market demand being higher for a certain tier than another, etc.

Besides the intelligent delivery based on user location and regional scope of the sponsor, there is an additional method of intelligent delivery combined with the above two methods of intelligent delivery. This utilizes another feature/service of the platform currently referred to as TasteTrak. In short, and as described above, TasteTrak is a feature/service that collects intelligence about a user's tastes, preferences, demographics, and other correlative data. These data may then be used by algorithms which generate additional user profile data based on correlations, demographic patterns, and other patterns and probabilities extracted from data of larger populations of users, one or more of which may be referred to herein as correlative data. Individual data items of TasteTrak intelligence have been referred to as TasteClues herein.

TasteClues may include, for example, one or more of factual intelligence, collective correlative database intelligence, collected real-time usage data intelligence, social network intelligence, and/or other information. Factual intelligence on a user's music collection, for example, may be parsed from the user's music collection stored on his MP3 capable smartphone and from other music services he is enlisted in such as Pandora, Slacker, Rhapsody, etc. Collective correlative database intelligence may reference an individual's user music intelligence to demographic data on users with similar tastes in music. For example, about an individual user we may only know that he listens to Band X quite a lot, but within the whole database, we may know that other users who listen to Band X have a correlation of r=0.89 toward predilection for NASCAR, or preference for gourmet cheeses. Collected real-time usage data intelligence may relate to the actions user take while they use the system. For example, the fact that a certain user clicks on 48% of the banners he sees for sportscars, but never clicks on banners for credit repair; or the fact that of all the events the user clicks on to get more information, 87% of the musical events feature classic rock, and 0% are for classical music; or the fact that the user has redeemed digital interactive coupons in certain geographic regions and that the coupons have been for certain products/services in particular categories/genres, etc. Social Network intelligence may relate to correlative calculations that can link an individual user to the tastes/preferences of his friends. To a certain calculable degree, the probability that a user is interested in a certain taste or preferences goes up, if his socially networked friends have that certain taste or preferences. TasteTrak gathers many other TasteClues that are referenced in other materials. The combination of TasteClues and TasteTrak intelligence for a given user can be carefully correlated statistically to banner statistics to calculate the appropriateness of targeting a particular user with a particular kind of advertisement.

After a banner is intelligently delivered based on user location, regional scope of the sponsor, and intelligence on user tastes/preferences/demographics, the next concern is that the user's interaction with the banner is an agreeable experience that caters to the user's interest, and actually assists the user in easily generating business for the sponsor. Thus the present invention is also directed to a Banner Interaction Model or system, which differs from the concept of “click-to-take-me-to-the-homepage-of-the-sponsor's-website” and provides an interactive experience catering to the user and catering to the facilitation of actual business. Some of the features of this system are described below.

Conventionally, most banners were static image based. Recently, some banners include animation and other interaction opportunities. In this model, a banner can be anything as primitive as a single image, to a video, to a miniaturized HTML 5 web app capable of expanding to fill part or all of the screen when interacted with, allowing full application-like interaction therewith. A simple tap can lead to the ITE described below, or, depending on the internally programmed HTML 5 logic of a fully app-like banner ad (described above), the ITE in (b) below can be triggered by any logical condition within the HTML 5 app that is determined by its internal programming.

In accordance with some implementations, Interactive Tap Engagement (ITE) may replace the status quo paradigm of “Click-me-to-the-homepage-of-the-sponsor's-website.” ITE ushers the user to an Interactive Tap Engagement screen that engages the user with a number of different interactive options and features that facilitate his interaction with the sponsor and the sponsor opportunity, as well as facilitate the sponsor with easily providing these different interactive options and opportunities (see Sponsor Engagement Model, below).

Some implementations may include an Interactive Tap Engagement Screen (ITES). Upon tapping a banner or interacting with a banner in such way that ITE is triggered, an engagement screen is provided to the user. In native client applications (such as iPhone or Android apps), this is application functionality that is built right into the client-side application and provided via SDK/API to client-side applications that wish to incorporate ITE. In other implementations it is conveyed via HTML interface such as HTML-5, or via similar technologies such as Adobe Flash, or other technologies which may enhance or replace HTML-5. Depending on options selected in the Sponsor Engagement Model, various options may be presented to the user in the ITES.

In some implementations, options may be presented to the user in the ITES via one or more icons and/or other interactive elements. Some examples of such icons and/or other interactive elements follow below. An icon of a telephone, that if pushed, may dial the telephone number of the sponsor from the telephony-enabled device. In devices without telephony, tapping this icon immediately presents the telephone number to the user. An icon of a globe (typically used to represent world wide web), that if pushed, may link to the sponsor's website, similar to status quo banner ads, except with the extra features provided described elsewhere, of sending a certain amount of information about the user (sensitive to privacy and permissions), the particular banner that generated the user interest, certain information about user tastes/profile/preferences, the platform the banner was on that generated the response, etc. An icon may directly link to the App Store or Market that serves the particular user's smartphone platform (e.g., Apple App Store for iDevices, Android Market for Android devices, etc.). This may be useful for sponsors who are promoting their apps to users and wish a direct way to close a transaction/purchase of their app by the user.

Further examples of options that may be presented to the user in the ITES via one or more icons and/or other interactive elements follow below. An icon may directly link to the sponsor's merchandise via a third party platform (e.g., buy product on Amazon, search product on priceline.com, etc.). An area on the screen, dimensions and scope defined by the sponsor, may begin playing a video or interactive video (such as can be implemented via Flash or HTML 5). An icon on the screen may directly link to a sponsor's video or videos. An icon on the screen may directly link to a sponsor's promotional photos or photo album. An icon on the screen may directly link to downloadable content such as, for example, executable programs, video, photos, eBooks, etc. An icon on the screen may directly link to a “map it” feature, that shows the sponsor's location(s) on a map, provides navigational services via onboard GPS functionality on the device, etc.

An icon on the screen may directly access “promotional punch card” (PPC) functionality. PPC is a natively implemented (or HTML-5 or similar) implemented digital version of the punch card model used where, for example, every tenth punch on a card entitles a user to a free coffee, or two-for-one dinner, or whatever else the sponsor wishes to give away in exchange for the frequency/loyalty of its customer.

An icon on the screen may directly link to the Digital Interactive Coupon (DIC) (or Location Interactive Promotion (LIP)), or alternatively, the DIC or LIP may immediately be presented in the first appearance of the ITES. This functionality is described elsewhere. Briefly, it is a digital coupon that can be securely redeemed via server-provided authentication/redemption services. It allows sponsors to digitally deliver coupon promotions to users via location/region/taste targeting, and then have those users come redeem the DIC in an action that ultimately generates business and results in closing a transaction. This may include Slide-to-Buy technology (detailed in further detail herein), which may in this case carry alternative nomenclature such as “Slide-to-Redeem”. In this particular implementation, Slide-to-Buy is implemented to facilitate coupon redemption and/or transaction fulfillment for merchandise, products, services, tickets, and/or other products and/or services to be redeemed and/or transacted.

An icon on the screen may provide a calendar of dates/events/information relevant to the sponsor. For a performing artist this could be tour dates, for a software or hardware company this could be release dates of new products, for a cafe this could be a schedule of live concerts featured at the cafe, and so on.

An icon on the screen may reference the Dibbs platform of events associated with that particular sponsor. These can be a venue's entertainment events (if the sponsor is an entertainment venue), or promotional events (anything from a Macy's Memorial Day Sale to a hole-in-the-wall bar's Happy Hour specials). Note that promotional events may be saved in a separate table of the EventScout database, but are essentially events like any other that the Dibbs platform keeps track of.

An opt-in or “subscribe” to this sponsor icon may allow a user to opt-in to the sponsor's promotions. This includes but is not limited to: automatic receipt of all the sponsor's digital interactive coupons inside the user's account (an “e-purse” or “e-wallet” of digital interactive coupons the user is carrying), e-mail offerings/solicitations, and automatic push notifications directly sent to the device to provide time/date & location-based promotional offerings based on real-time intelligence and relevance.

An icon on the screen may link the user to the sponsor via social networking. That is, the link may connect the user to the sponsor's facebook, twitter, myspace, dibbs social network, and so on. An icon on the screen may be configured to “share”, which is the name and method in current parlance for sharing whatever one is currently looking at, doing, thinking, etc. with friends within one's social network. In this case, the sponsor ITES gets immediately shared with a selected friend or friends within the user's social network, as accessed by the Dibbs Platform's proprietary social networking functionality and features, and/or other social networking platforms and/or third party social networking functionality.

An icon on the screen configured to “track,” which is a more passive version of opt-in. When a user chooses to “track” a sponsor, they passively collect promotional information about a sponsor within a certain compartment of their user account, which requires them to proactively enter that compartment and select from among different “tracked sponsors” to see intelligence the user has passively collected about various promotions/events/information/etc. relevant to that particular tracked sponsor. Passive tracking is different from active opt-in where a user is directly engaged with promotional e-mails, notifications, etc., the latter by their nature being somewhat more intrusive and more likely to be felt as annoying or “spam”.

Implementations of the present invention may be directed to a Sponsor Engagement Model or system having some of the exemplary features described below. The ability for a sponsor to easily engage this new internet protocol based marketing paradigm may be crucial. Previously, sponsors would be made to “jump through hoops”, having to upload banners, fill in complicated information sheets and delivery sheets, bids, fill in data that vaguely references proprietary processes only half known, and of course, providing the URL to which a click on the banner will take a sponsor. The Sponsor Engagement Model naturally does require some information on the part of the sponsor in order to get an interactive banner posted through the service, but it is done in such a way that we'll call “fire and forget”.

One or more features of the ITES may be displayed through a Sponsor Engagement Screen, which may allow sponsors to immediately and easily configure all features of their interactive promotion. In most cases it is as simple as a list of check boxes for each of the over 17 features, configurations, and options; with the sponsor selecting certain check boxes as activated and others as not activated. In some cases where content is needed, the sponsor clicks on typical user interface controls to specify more detail (such as which image to user for a banner, which video they want to be activated when a user selects their video, type out the URL of their website, etc.) All this information is saved on the server side so that next time the sponsor engages in signing up for another promotion, he may immediately fill in options he has already used before (such as the URL to his website, etc.) The Sponsor Engagement Model therefore provides sponsors with an ultra-convenient facilitation model that in a matter of a minute or two, lets them specify a unique combination of over 17 interactive promotional features. Even the smallest brick-and-mortar bar-and-grill sponsor who does not even have a website, is in no time at all able to create coupons, enlist customers to join his social networking circle (such as Facebook, twitter), provide users with a phone number to call and map directions to the establishment, provide users with a button to tap to immediately see all upcoming events at the establishment via the Dibbs platform, and so on.

Some implementations may include “cash back” style promotions. Credit cards engender a greater degree of usage by kicking back customers to use their card. They are able to do this because they generate revenue off transaction fees, some of which they give back to the user through point-based promotions, which in turn engenders more usage and more revenue for the credit card company. In a similar manner, Dibbs engenders a greater degree of usage by giving “cash back” in the form of points which represent “virtual currency” or “Dibbs Dollars”, as detailed elsewhere. Responsive to a user clicking on a particular banner, the user may gain a certain number of points or “Dibbs Dollars”. Responsive to a user interacting with the ITES for a long enough period of time or in such way as it represents legitimate interest rather than mass-clicking just to gain virtual points, the user may gain a certain number of points or “Dibbs Dollars”.

In some implementations, the TasteTrak system may include one or more of TasteTrak Intelligence, raw data intelligence, Algorithmically Generated Intelligence (AGI), and/or other features. With TasteTrak Intelligence, the TasteTrak system may operate through one or more key items. First, collected intelligence and the methods used to collect that intelligence. Second, the algorithmic processing of that intelligence that results in the generation of more valuable intelligence above and beyond the “raw data intelligence” of the first item.

With raw data intelligence, TasteTrak raw data may be collectively known as TasteClues. TasteClues may include, but are not limited to, Binary Leveraged Questionnaire Intelligence, Question Freedom for Enhanced Question Productivity, Arbitrary seeming correlational data, MyStar Ratings, Real-time Intelligence, Real-time Interaction, Content Intelligence, Social Networking Intelligence, and/or other information.

Binary Leveraged Questionnaire Intelligence may include, for example, the game of 20 questions or other questionnaire format, which utilizes the power of a “binary tree” designed to elicit the most information and/or eliminate the highest number of possibilities, in the least number of questions. In the example of the game of 20 questions, a player uses what is referred to as “binary leverage” to guess almost anything in under 20 questions, since binary leveraged questioning can through the process of elimination narrow down on 2²⁰ possibilities in only 20 questions. Binary Leverage Questionnaire intelligence uses the same type of “binary leverage” to intelligently elicit a deeply sensitive taste profile in the least number of questions possible. That is, things that are known about the user (through prior questions and other collected data) are algorithmically combined and considered alongside things that are suspected (i.e., probably true based on prior questions and correlative data), and additionally considered alongside facts that would be most useful to know about the user, given what is known about the user, not yet known about the user, and what is known to provide the most traction based on patterns in other users. At this point and based on this information, “binary leverage” is classically applied in the questioning sequence to elicit the most useful information in the least number of questions, as applied to the gathering of digital TasteTrak data to be used in providing the user with superior and user taste customized services regarding advertising, promotions, event information, and/or other factors.

Question Freedom for Enhanced Question Productivity may include specification targeting. Not all users need answer all the same questions. This is already a feature of using binary leverage, but it can be used further. Other TasteClues will often gather ambiguous intelligence that gives vague probabilities about what a user may or may not like, while still not being definitive enough to know for sure. If a user is friends with lots of people who love Jazz, it's a good indication they may like Jazz, which increases the probability that asking a Jazz relation questionnaire item will have greater productivity in determining user taste. If a user visits a venue several times, it makes it a good chance that the user likes venues of that particular kind (but it may mean that he hates the place and only shows up to give a friend a ride home). In other words, any other TasteClue in the system, or combination thereof, can, via algorithms, indicate a greater likelihood the a specific question will be more productive in discovering relevant user taste information about a specific user.

Arbitrary seeming correlational data (and statistical probabilities data, pattern recognition data, neural network data, etc.) may represent information that does not at first blush seem relevant to generating any useful intelligence. For example, a preference for chewing tobacco does not at first seem to provide any relevant information for predicting what events a user may like to attend, until the system begins cross-correlating all TasteClues to discover that this information is highly useful and relevant in predicting a predilection for, by way of non-limiting example, country music, rodeo, NASCAR, and certain products like American pickup trucks. Consequently, the above two items for questionnaire intelligence and “question freedom for enhanced question productivity”, can and will in some implementations, harness arbitrary seeming correlation data via the presentation of questions that are “arbitrary seeming” or at first blush do not seem to be relevant in generating intelligence that helps the platform serve the user.

For a community to determine the quality of something, a number of people may be surveyed and asked to rate popularity, such as on a five star scale. This method assumes “popularity equals quality”. In fact, popularity only very loosely correlates to quality. If a particular user dislikes Top 40 music, then for that user, popularity would actually negatively correlate with quality. MyStar Ratings may include a more sophisticated and artificially intelligent system of weighing the votes and rankings of others according to how similar their tastes are to the user's own. Therefore, the number of stars assigned to an event is no longer an objective universal, but a subjective particular that is different and differently assigned to each user. MyStar may focus on the message of it providing ratings that are custom suited to a user's tastes. This will make users much more likely to use feature sets that involve MyStar. Most informative of all is the user's ability to vote on every artist, venue, and event. Such ratings are directly informative to the user's tastes, as TasteClues. A classical rating system would take the votes of, for example, 5 users, add them together, then divide by five to produce a universal rating. This is currently a popular format wherein ratings, such as ratings from 1 to 5 stars, may be assigned by users of a platform to restaurants, movies, music, and/or other ratable products and/or services. MyStar similarly produces a rating, such as on a 5-star scale, but it is absolutely distinct in that the rating is not universalized for all viewers of the rating. MyStar may for example, take the votes of 5 users, multiply each vote by a variable w which represents the “taste proximity” of the user who made the vote to the user who is viewing the rating, and then divide the final result by the sum of all w variables associated to each voting user. The w variable, which is the weighting based on taste proximity, is calculated by an algorithm which compares the similarity of the user's taste profile to the taste profile of other users who have voted/ranked, via formulaic methods which those skilled in the art use to quantify the similarity of one dataset to another dataset.

Real-time Intelligence may relate to user clicks. For example, every time a user clicks on an event because he's curious, there's information there. How long does he spend reading the description, and looking at the content (pictures, videos, etc.) A quick in-and-out means something different from a user who binges on photos and sample video. Likewise, mapping an event shows a higher degree of interest. While this specific TasteClue is the least reliable and definitive of all other TasteClues, it nevertheless provides information that can be highly valuable to other algorithms using other TasteClues, in making finer determinations.

Real-time Interaction may be related to but of a slightly different genre of TasteClue from Real-Time Intelligence. The Dibbs User Interface will provide the user with certain UI controls for interacting with events in real-time, specifically for cluing in TasteTrak. A user may show disapproval for a certain artist, venue, or event, by making a disapproving swipe over the entry. Or click a button for a thumbs-up thumbs-down. Select “never show me this artist again, I hate him”, and various other combinations of hate/love as it relates to artists, venues, events, and genres (of music, etc.). Interaction with banner sponsors provides another TasteClue in this genre. Interest in a certain type of sponsor or promotion provides important demographical information that, through algorithmic processes, becomes correlated with data from other users to generate more valuable intelligence. For example, a correlation or probability or fuzzy match equal to 0.95, that users who clicked on a certain type of banner like a certain type of music, is later valuable insofar as vendors who peddle that type of merchandise/service can now target users who like that certain type of music.

Content Intelligence may relate to the user's content. Smartphones can host MP3 music libraries, as well as video. They also contain libraries of user downloaded applications. They also contain histories of websites visited, content accessed via internet, raw data that with minimal processing can reveal informative data such as number of text messages sent by the user per day on average (which may correlate with social gregariousness which may in turn correlate with other demographics and fuzzy values/likelihoods/correlations of other taste preferences), and so on. Other forms of content intelligence are subscriptions to content providers that can be indicated by the user on sign-up or at other times during use of the service (Pandora, Slacker, Rhapsody, Hulu, etc.) Purchase of tickets to an event can be thought of as Content Intelligence, due to it providing information about the event, event genre, artist, artist genre, venue, venue genre, demographical clues about disposable income or amount of money allocated to entertainment, etc.

Social Networking Intelligence may be provided by Dibbs' Social Networking Engine, which may be configured to aggregate information from every social networking channel, in addition to generating new and important channels of social networking. There are two main subchannels of information within this TasteClue. First, user's existing social networking channels provide highly informative information. Their accounts may contain “friendships” with various artists, bands, and venues. Additionally, users list their tastes of “what they're into”, which include genres of music and other predilections which are highly informative. Secondly, Dibbs' new channels of social networking provide informative information. Dibbs allows users to suggest events to their friends, advert to their friends of what events they are going to, and invite their friends to events. Naturally, all of this information is a valuable and directly informative TasteClue for TasteTrak to utilize.

Algorithmically Generated Intelligence (AGI) may operate on raw data (TasteClues) to generate intelligence above and beyond what is immediately apparent in the raw data. For example, raw data simply shows how many people have the Rolling Stones as one of their favorite bands, or how many people enjoy eating out at Italian restaurants. AGI can look at all users with a predilection for both the Rolling Stones and eating at Italian restaurants, and discover that among all users with a predilection for both, there is, for reasons beyond gleaning, a 92% correlation (or fuzzy predictive value) with a predilection for travel to Mexico, or for wine tastings. This, for example, may become informative for sponsors of Mexican vacations, or for displaying event information for wine tastings with a higher MyStar ranking/sorting.

In the broadest sense, AGI is generated through two key mechanisms, with a third mechanism being the combination of the first two mechanisms. In one mechanism, correlational data may statistically track correlations of raw TasteClues among all users within the database. It may be that among all people who believe in UFO's, there is a 0.82 fuzzy predictive value for preferring Pepsi to Coke, and that among all who prefer Pepsi to Coke, there is a 75% probability that they prefer rock to jazz. The system may always contain only incomplete information about a user, but via such information above that can be generated by processing the larger amounts of data available among all users in a database, likely information about a specific user can be generated. For instance, using the above example, the system may know that a user believes in UFO's, but contain no information about Coke/Pepsi or rock/jazz. Secondary information is generated, producing a probability, correlation, or fuzzy value representing the likelihood of a Coke/Pepsi preference, which can then be generated to produce tertiary information on a preference for rock over jazz. In such way, secondary, tertiary, quaternary, [and so on], information can be generated by the system, as long as the correlations, percentage co-incidences, weightings, and/or fuzzy values produced, continue to be significantly strong or significantly weak to produce some kind of informative likelihood about a user's tastes. The generated AGI may be useful in determining MyStar ratings by which event information is filtered, ranked, sorted, and/or displayed, and/or for serving sponsors with taste-targeted banner advertisements to an audience who is likely much more interested in their product/service offerings.

In another mechanism through which AGI is generated, pattern recognition algorithms may utilize the above data to generate further AGI. These algorithms can be any number of algorithms used by those skilled in the art, such as neural networks, fuzzy clustering methodologies, and so on. In general, pattern recognition algorithms look at large groups of data to elicit hidden patterns. In one instance of such a system, it may be that among all users in the database, 96% of users who exhibit a similar pattern among 27 arbitrary TasteClues, exhibit other patterns among other groups of TasteClues. While 96% measures a raw statistic, this number could also be a fuzzy value which abstractly represents likelihood without being an actual percentage, or an r coefficient for correlation, or any other calculated value that those skilled in the art use to weigh likelihoods, co-incidence, correlations, recurring patterns, and so on. Such methodologies which are able to find clusters of facts that together indicate intelligence about other clusters of facts, go far beyond the first type of AGI which merely correlates (or indicates a percentage of co-incidence) between any two facts.

According to yet another mechanism through which AGI is generated, expert systems and rule-based intelligent systems are amalgamations of raw data, AGI (such as the above two forms of AGI), and logical rules which operate off of conditions and numerical weightings, to make decisions which are intended to be more intelligently informed and guided. This combination of all above methods into processes and algorithmic logic, is an [optional] third method of producing AGI. Often, but not always, there is an arbitrary human art to these systems, such as the algorithm incorporating the artful human decision that an 84% likelihood (or r=0.84, or fuzzy value of 0.84, etc.) of a taste match is the threshold at which to display an advertisement from a sponsor, or to display an event in a list of events likely to appeal to a user's tastes.

Alternative harnessing of TasteTrak System for internet protocol based marketing may include the use of one or more of the above mechanisms to generate intelligence that connects sponsors to users more likely to be interested in their promotion. This feature of TasteTrak may operate nearly identically to the list of events to users based on the likelihood that the user will be interested in attending that event.

Some or all of the information described herein may be used to generate a multi-dimensional geometric space of event taste information, with correlative and/or quasi-neurally networked characteristics for each user in the system. This information is then used by a plurality of specialized algorithms which are components of the master EventMatch algorithm, whose major purpose is to assign a number or value (e.g., from 0.0 to 1.0) which represents for each event (or for each banner sponsor), how much that given user will like that event (or banner offering). In some implementations, other variables may refine the intelligence surrounding that number, such as a variable from 0.0 to 1.0 representing the degree of certainty for the first number, and so on. EventMatch ratings are directly transferrable into MyStar Ratings. For example, an EventMatch score from 0.0 to 1.0 can be turned into a 5 star rating by multiplying the EventMatch score by 5.

In accordance with exemplary implementations, a User Taste Canvas may relate to any number (e.g., dozens, hundreds, thousands, or more) of points in an n-dimensional space, matrix, vector, or other mathematical construct, that show what a user likes and dislikes. For example, for each song in a user's collection, a point will be recorded for its location within the n-dimensional space, or a vector of feature components may be stored for each of the n number of features known about the song/artist/genre in the TasteTrak database. The density of points and/or feature components in certain areas “outlines” or suggests areas of preferred taste.

One or more implementations may relate to demographic overlap/correlation data collection. Users with high positive overlap in user taste canvas, as well as demographic information (age, location, ethnicity, socioeconomic status, etc.) help facilitate the system's guesswork/knowledge of each other's tastes. Therefore users of similar taste and demographics actually provide the raw data that becomes AGI data for each other, such that the system can use the AGI data to better estimate tastes of individuals within the system.

In some implementations, the invention may be directed to systems and methods for Aggregating Multiple Social Network Channels under Abstractly Layered APIs to provide users with Instant, Mobile, and Powerful Social Networking capabilities. Many would argue that human attended events are inherently social, such that information about events and processes that facilitate the attending of events, are greatly enriched by providing information and facilitating processes in the social dimension. The Dibbs Platform weds the current state of the art in all aspects of social networking, into the unique milieu as it relates to event information and facilitation, using unique innovations and combinations of features and functionalities in new ways, among other things.

Social networking, while a great concept, has been hampered by the same problem as eCommerce: the input paradigm. Users are forced to find a computer, log in to the computer, pull up a browser, log in to their social account, etc. As a result, primitive and simple social networking and communications (such as text messaging) continue to dominate over forms of social networking that are theoretically more powerful and functional, due to the inescapable primacy of mobility, immediacy, and ease of use. Dibbs' SocialNet is a natural extension of Dibbs' core architectural philosophy of incorporating a multiplicity of aggregation schemes (“tentacles”) into an intelligently organized hub that abstractly reorganizes, recombines, and repackages the aggregated content and media into something much more valuable than the sum of its parts. Synergy with Events creates competitive advantage. Events are things people travel to in groups. Essentially, events are social happenings. Anything that provides a greater degree of social networking, social communications, social organization of group outings, etc., immediately becomes an enhancement that is a competitive advantage over other events platforms.

Viral and word-of-mouth marketing rapidly propagate across social networks. Having a revolutionary social networking platform coupled with the rest of the platform immediately translates into a revolutionary marketing vehicle. Various marketing programs that Dibbs conceptualizes can immediately use this vehicle to garner traffic, grow user base, and pursue brand dominance.

Many of the functional systems that Dibbs already takes advantage of, go a long way toward enabling the opportunity of creating a social networking component. Smartphone application technology platforms come pre-enabled with the ability to peruse information from telephone contact lists, send text messages, make phone calls, send e-mails, receive push notifications, etc. In addition, Dibbs will already have a base of registered users. It is not too much more effort to create program code to facilitate finding out which registered users are in each other's social networks. New APIs are being released by various social networking platforms to create more reliance on their particular social channels, in other words, to garner and maintain their user bases. This means that external platforms (like Dibbs) can fairly easily hook into and utilize existing social networking channels. With all the above opportunity already in place, the creation of SocialNet is a natural and logical extension of the Dibbs platform.

SocialNet stands at the hub of a variety of distinct social networking channels. Each of these channels can be thought of as one of SocialNet's “tentacles.” These are all aggregated through various layers of abstraction into a single meta-service that has more social networking functionality than any other. Features of SocialNet may relate to friend “playlists,” friend aggregation, event intentions, event invitations, event attendance and/or RSVP, event presence, media content sharing and/or blogging, ratings, comments, content provision, private events, group buy, and/or other information.

A friend “playlist” may be analogous to a playlist in music, but for the user's friends. A friend playlist may provide the ability to organize the user's friends into genres and categories. Create a message and select which “Playlist” to send to. A-List, B-List, work buddies, church friends, bar buddies, upwardly mobile friends, family friends, party friends—whatever circles of friends the user's lifestyle has created. Playlists can be configured by event type. If the user is out at a business networking type of event, the user's business colleagues playlist defaults to being selected for the user's attendance notifications, invites, etc. If the user is out late at night, the user's Playlist(s) for the user's closer circle of friends can be defaulted as selected and the user's church buddies list is defaulted to off. If the user is out to see Jazz, the user's Playlist for music friends who like jazz (if the user has one), can be defaulted to on, while others are defaulted to off.

Friend aggregation may provide the ability to find the user's friends from multiple sources and aggregate them into one comprehensive list. Some of the user's friends are on LinkedIn but not Facebook. Some are on Dibbs, some are not. Some are in the user's phone's contact list, some are not. Dibbs is the only place where all the user's friends are aggregated. The user can create a message and send to a Friend Playlist, and that message will find its way to the right friends through the right channels, based on a “prioritized cascade” where for each friend in the Playlist, it looks to see if they are on the higher priority channel first, and if not, the next priority channel, and so on, until it finds the highest priority channel on which they are networked to the user, and then sends out the invite/message/notification/etc. For example, the cascade may go as follows: if (SMS) then send SMS, else if (on Dibbs) then send via Dibbs, else if (on Facebook) then send via Facebook, else if (email) send via email, else if (mySpace) send via mySpace, and so on. The prioritized cascade can include an additional degree of complexity: that is, specialized logical conditions that allow for multiple channels to be used in distributing a social message/notification/invite/etc. For example, if the user is on Dibbs, the message might propagate only via Dibbs, but if not on Dibbs, the message might propagate via Facebook and email. Particular users of Dibbs can set their own cascade settings so that when other users socially message them, the propagation will occur according to their own preferences.

Event intentions may allow the user to indicate the fact that the user is considering going to an event, marked by the user with a single tap while the user is viewing an event inside Dibbs. When all the user's other friends are using Dibbs, they can see that the event has been marked, and that one (or more) of their friends are thinking about going. A quick info tap, and they can see which friend or friends are thinking of attending. They can then respond that they too are thinking of going, or they can decide to message the user a communication about what they think of that event, convince the user that the user might want to attend another event instead, etc.

Event invitations may relate to features of SocialNet. After the user decides that the user is going to an event, the user can broadcast invitations to the same event, to selected “Playlists” of friends. The user doesn't need to care who is in Facebook, who is on MySpace, and who is on none of those . . . They will all get the message thanks to the SocialNet messaging abstraction layer.

Event attendance and/or Event RSVP may relate to features of SocialNet. If the user decides that the user is going to an event, the user can broadcast the user's future attendance of that event to selected Playlists of friends. The user can RSVP a “yes” to invitations the user gets from other friends. The user's friends will now know that the user is going to a particular event, and it will show up when they view Dibbs event listings right on the Dibbs Platform.

Event presence may relate to features of SocialNet. Basically, a user may tag “I am here now”, and all the user's friends looking for what to go do can now know which event the user is at, and see it marked in the events listing via a different highlight color for that event, and/or via other iconic marking.

Media content sharing and/or blogging may relate to features of SocialNet. While at an event, the user's smartphone has photo and video features. The user may take a photo or video and post it on the platform. The user's friends can get the photos automatically delivered to them directly, or when they are browsing events, see the friend is at an event, and tap to see the photos and videos their friend has posted. This media content can be published to all users of the platform. If a picture is worth a thousand words, a video is worth a thousand pictures. Supplementing textual event descriptions with rich media significantly enhances the content of events listings.

Ratings, comments, and/or content provision may relate to features of SocialNet. This plays along with content sharing and blogging, but in the specific sense of “voting” how much the user likes where the user is at: the event, the venue, the artist, the crowd, the level of fun, etc. Comments can be text comments that others in the user's friend lists can see when browsing events on the system. Or alternatively, the comments can be public for all. Content provision: attendees of events can take photos and videos of the event, and “tag” the event in the main database with this content. Thereafter, others in the user's friend lists can see this content when browsing events in the system, or alternatively, the content provision can be made public for all to see.

Private events may relate to features of SocialNet. Regular users may post events in spite of not being a venue affiliate. Via a banner portal, in-app widget, website, and/or other interface, the user can post his private event and then select which Playlists of friends will be able to see it. Examples of private events are dinner parties, ski trips, boating expeditions, camping, fishing on the houseboat, and/or other events. These events will show up on the events listing whenever the user's friends use the platform, mixed right in with the list of all the public events. Private events may be marked with a different highlight color, so they will immediately know that this particular event is a private event hosted by one of their friends. Coupled with the Event Invitations service, this makes for a very powerful tool for users of the platform.

“Group buy” may relate to features of SocialNet. Once a group of friends has decided to attend a paid event, a convenient feature may exist for friends to execute group purchases. This feature may be especially helpful for a number of reasons. For example, (1) when friends want to sit next to each other in adjacent seats (for non-GA events); (2) when some friends want to “gift” attendance of an event to other friends; (3) when no one wants to be left “holding the bag” buying the tickets, because someone may cancel, or it was just too much trouble to arrange a group buy with existing methods of communications, the hassle of logistical arrangements, etc.; (4) when the user is attending an event with another friend but not arriving at the same time, and doesn't want to wait by the door to pay her way in, she may want to buy two tickets (or cover charges), and then use SocialNet to zip the ticket straight over to the friend's smartphone; and/or other reasons.

Social Event Networking may include further features of the invention. The user may RSVP to an event that the user views in the screen, then when other users in the user's social network look at the event, it displays how many of their friends are going, and they can then through user interaction expand that into an immediately viewable list of friends who have given RSVP. It is also possible, while viewing events and selecting the RSVP option, at that time to select from a menu of the user's own social network to select which of the user's friends to alert of the user's attendance and issue a co-invite. The invitation will then propagate to the user's social network (1) via push notification sent by the platform to the user accounts of others in the system, and (2) via third party social networking accounts (facebook, myspace, etc.), which typically their own event invitation messaging services which are similar to emails that they receive when logging onto these third party social networking accounts or via other means such as, for example, platform inbox and/or SMS.

“Social Banners” are banners that users are able to post to their own social network within the system. They can create the banner by assigning it text and/or pictures, which then becomes amalgamated as either an image (JPG/PNG), or as an XML information bundle which contains data instructing native client applications how to “draw” or construct the banner client side. Social banners appear in the exact same region that normal advertisement banners do, within the web page or native client app. Social banners may be directed to appear FIRST when the app or web page is launched, (or second or third), or according to a programmatically determined algorithm which staggers social banners with conventional banners. A social banner may contain a URL that links somewhere, or may contain an XML bundle (or other type of data information bundle) which describes how, when the social banner is tapped, it engages the native client app. For example, a social banner may link, through information contained within the XML information bundle, to a certain place in the app, to a certain event within the app, or to anywhere else within the app (such as the place in the app to give an RSVP response to an invitation). In the case of linking to within the app, a method of “URL interception encoding” to create is utilized to allow the app to “know” that rather than launch a webpage, it should redirect program flow to a certain place within itself. Normal URL parameters in the form of ?parameter1=val&parameter2=val become the internal parameters passed through the in-app method call. In some implementations, the URL may be a valid webpage such that, if the user is accessing a banner through a browser, he is directed to the proper webpage, via URL, to fulfill his request. However, special codes inside the URL, which are effectively ignored by the browser and/or web page which receives them, still flag the app to do an in-app redirect. For example, there may be a parameter in the URL such as ?inapp=yes, effectively ignored by the web page specified by the URL, but detectable as a string sequence by the application which then flags the indication to not launch the URL, but rather, to interpret other URL parameter encodings as information indicating both the place to go within the app, and what informational values to pass to that place within the app as informational data parameters. In this way, a social banner may actually portray that the user is being invited to an event, and then when tapped, take the user to the exact place within the app where they are presented the option to accept or decline the invitation. (While these compete with slots for advertised banners, the occasional appearance of a social banner may make more people conscious and aware of banners, likely increasing rather than decreasing the value of the commercial banner slots.) Social Banners can optionally be (1) free; (2) acquired on a limited credit basis, so that one person has a limit to the number of banners he may post in a certain time period; (3) be acquirable with “Dibbs Dollars” (see below), “Social Pull points” (see below), or other Gamesmanship credits/points (see below); and/or (4) actually purchased for a nominal amount (like $0.50, etc.), with the transaction immediately debiting from the user's pre-existing Dibbs account.

The TasteTrak profiles of “trend setters” (also see Gamesmanship below: people who accumulate higher ratings by having more “cool” friends and doing more “cool” things) can be swapped in and out before viewing events. When viewing events, the default may be that events are shown according to the user's own tastes. But, the user may view events according to the tastes of others: (a) those in the user's friends group who've permitted it, and/or (b) those who have scored high in gamesmanship for certain things, such as “King of Cool”, “Prince of Jazz”, and so on, with permission. In addition to swapping and/or interchanging entire user taste profiles, users may swap or interchange “composite clusters” of taste profile information while leaving the rest of the profile untouched. For example, a user may want to swap in Wynton Marsalis' taste profile only as it relates to the genre of jazz music. The user selects the jazz genre for the swap, and only those vector components and/or other data related to jazz and temporarily installed into the profile. In other implementations, it is possible to specify a permanent download for all of the above, rather than a temporary swap. A user could then download Wynton Marsalis' taste in jazz and Mick Jagger's taste in rock music, or perhaps his best friend's entire taste profile, into his own taste profile. In some implementations, when users first start the service, they may be able to pick “canned” taste profiles which best describe their tastes, as a starting point, so that the system already has a decent approximation of their tastes without requiring an inordinate amount of input and time to start making valid taste predictions.

In some implementations, the invention may be directed to a system referred to hereinafter as the SecureGive System which may be an independent platform technology, or incorporated with the Dibbs platform via SocialNet and/or the DIT. SecureGive may be configured such that the user's friend may authorize the user to buy his ticket on the Dibbs Platform, for a certain event. Via SocialNet, the user becomes aware that this has taken place. SecureGive may be configured such that the user buys both tickets. As the single person doing it, the designated agent, the user is able to get around all the logistical problems of two people buying adjacent seats on separate transactions. The user picks the seating for both people. Then, if the reimbursement option was selected, then because the user has prior authorization, the system may automatically reimburse the user through the user's friend's payment, charge both cards for the single transaction, and/or credit the user's card for one of the seats after it successfully charges the user's friend's card for the other seat. Because of transaction fees involved in the model, SecureGive may include a small service charge on top of the transaction, partly to cover the transactional costs, and possibly to generate a surcharge revenue stream. SecureGive may be configured to allow transferring of an already purchased ticket that was not pre-authorized to someone else, to a person selected right in this moment, in real-time, via internet connectivity, Bluetooth, 802.11 networking, NFC, or other readily available means.

One or more implementations may relate to a Digital Interactive Coupon and Location Interaction Promotion Service. The Dibbs system and its databases contain data tables of events and data tables and software programs for digital interactive tickets. By serendipity, this exact same system is functional to serve as a data table of brick-and-mortar vendors and data tables and software programs for digital interactive coupons.

An “event” in the main system is a certain kind of happening tied to a venue. In this sister system, an “event” is a certain kind of “special” tied to a vendor. A DIT, in the main system, is a certified, secure method of authenticating rights to obtain entry to an event. A DIC, in this sister system, is a certain kind of certified, secure method of authenticating the user as having the right to redeem a coupon to obtain a special deal. Therefore, by “shoehorning” the model for vendors and specials into a sister system structured the same as the main system for venues and events, a complete and sophisticated turnkey system arises for presenting, promoting, and/or facilitating vendor specials to users.

In one implementation, the user buys the coupon, and redeems it at the sponsor's location for merchandise or services. In another implementation, the user redeems at the point of sale and pays in full, and is credited the coupon amount to his Dibbs account via a validation code activated by the vendor. In another implementation, the user “buys” the coupon itself, which now becomes representative of a proof of purchase which can then be redeemed for an item. In this and other cases, some implementations will use ATHSS technology (detailed below), and other security measures of the DIT serving in the same capacity for the DIC, as security against counterfeit and fraud. The vendor then receives a payment for its share of the transaction via an electronic transfer.

Banner advertising generates the ITES which has provides the option to see a vendor's ITES. However, Location Interaction Promotion Service and Digital Interactive Coupons are not dependent on banner advertising. Banner advertising simply takes advantage of them. DICs and LIPs can be accessed through other menus in the Dibbs platform and/or outsourced through web services, API/SDK, and so on, to other platforms.

A customer, from the main menu, can push a widget button to see all the specials, sales, and coupons going on around him based on his GPS location. They are listed in terms of distance from current location and expiration date, in the same way that events are listed by current location and event date. Clicking on a vendor's special is like clicking on a venue's event. Instead of taking the user to an events description page, it takes the user to a special promotion page that describes the special being offered and any conditions and terms attached thereto.

There may be one or more similarities and/or differences between DIC and DIT. A DIT can always only be redeemed once, whereafter it is “ripped”, used, and expired. A vendor can select whether his DIC can only be redeemed once, the same as the DIT. A vendor can select whether his DIC can be redeemed over and over again so long as it has not reached its expiration date. A vendor can select whether his DIC can be redeemed x number of times, whereafter it is no longer valid. In some implementations, a vendor can select whether his DIC does not need to be redeemed at all, and merely presenting it graphically on the smartphone, and/or merely mentioning it, enables the customer to obtain the offered special. A vendor can select whether the DIC is transferrable to others. Like a ticket, the user may lose the user's coupon by giving it to someone else. Alternatively, the DIC can be replicated to as many unique people as possible, in which case each new person to hold the DIC is subject to one of the conditions above, as selected by the vendor. Security tracking inside the DIC (basically, identification codes tracking its transfer history) would ensure a DIC that underwent a restriction was not transferred back to the original sender in order to circumvent its original restrictions.

In some implementations, the DIC represents a disposable “chit” of information that informs people of a sale. For example, a Macy's All Day 30% off sale is not a coupon, but is universally offered to all who enter the store. The “digital interactive coupon” in this case may be named a “location interactive promotion” or otherwise, and simply graphically represents the fact that there's a sale. However, it does functionally represent other DIC/DIT features that go above and beyond, such as the ability to transfer the coupon to others in the user's social network, find the vendor on the map, and just as the DIT can be used to order concessions at some venues, the DIC could be used to ask for service or ask specific questions into the store's “cloud” at locations which support that feature.

The Digital Interactive Ticket may include one or more graphical representations. A graphical representation of the DIT may be a two-sided entity, much like a paper ticket. The user has the option to “flip” the ticket, through UI features or via an accelerometer generated internal event, to see its reverse side in order to expose one or more additional features. Such additional features may be configured to map the venue, optionally using GPS and navigation, if the mobile device has them. Such additional features may be configured to map the user's seats such as, for example, how to get to the user's seat from the front door (or various other doors), optionally using GPS, if the mobile device has them. Social Networking features may let others know the user is going to a venue and/or event. Social Networking features may let others know about the event and offer them a link that a) takes them to the website where they can buy the ticket, b) automatically launches their native client software app on their mobile device to buy the ticket from inside the mobile device app. Social Networking features may allow the user to comment, post, write, and message their own personal communications about attendance of the event. The additional features may facilitate ordering concessions to a location-specific assigned seat. One or more of these features may be adaptable to the DIC as well, where appropriate.

EventScout may gather preliminary information about events from users themselves. Users post preliminary information about an event and mark it public (as opposed to private, which is then only accessible to selected friend lists within their social friend network). This preliminary information goes into EventScout's “authorization hopper database” to receive internal confirmation about accuracy of the information and acceptability of the event posting.

The invention may include an accelerometer triggered hologram security system (ATHSS) which is a means of providing additional security to mobile apps/services that display any kind of authentication/confirmation/ticket/pass/identity/credit card/etc. in digital form via the screen of a smartphone or other portable electronic device with a user screen and accelerometer.

Many physical (e.g., plastic or paper) forms of confirmation/authorization/security/authentication exist for tickets, passes, identities, credit cards, and/or other credentialed physical forms representing abstract rights. Stamps are put on paper, holograms are put on credit cards, stock certificates, titles, registrations, and even on some nations' currency. As mobile devices become more ubiquitous, many paper/plastic/physical systems for representing the bearer's abstract rights to funds/transactions/money/entry/permissions/authority/etc. are becoming digitally incorporated on mobile devices. However, a problem exists where digital information is more easily duplicated than physical objects. Graphical images and video, for example, can be replicated and duplicated ad infinitum. The system described below provides a method of providing certification/authentication/security/authorization/etc. to the digital implementation of representations of abstract rights that the bearer is entitled to upon presentation of the physical or digital representation thereof.

The system provides a method of implementing the hologram feature present on credit cards, certificates, titles, national currencies, etc., on a mobile device. A “digital hologram” is graphically represented on some area of the graphically represented certificate/credit card/ticket/title/etc. The software that represents the hologram does it dynamically while listening for internal digital events that are triggered by the accelerometer's sensitivity to the physical movement/motion of the mobile device, and [optionally] the internal compass of the device, and/or intensity of light sources through sensors on the device, camera lens, proximity sensor, etc. The orientation and position of the device is determinable from the accelerometer and/or internal compass. An arbitrary or predetermined light source is then fixed, relative to the position/orientation of the mobile device, and optionally, real-time memory of light source intensity as the devices moves and changes orientation. As the device moves along x/y/z axes and changes orientation relative to the predetermined “imaginary” light source or real light source data, algorithms determine an actual reflection/refraction pattern that the virtual hologram portrays in relation thereto. This can either be verisimilitudinous, and mimic a virtual reality of how a certain hologram would react to a certain light source, or a “virtual alternate reality”, where the reflection and refraction patterns are algorithmically determined by formulae distinct from those formulae which model physical reality, in order to create patterns even more unique and complicated that are thereby harder to counterfeit, and/or create distinct patterns whose uniqueness can be assigned individually for each unique certificate/ticket/title/credit card/etc., such that a counterfeit hologram that was created once, might no longer be applicable for other digital representations of abstract rights, due to the fact that the behavior of the hologram varies uniquely for each abstract representation to which it is assigned. In this manner, the animated behavior of the virtual hologram may serve in the capacity of an additional security code, badge, passphrase, etc., that alone or in tandem weds to other security measures which substantiate the authenticity of the bearer's digital rights. Methods described elsewhere, such as digital security codes, images or animations of colors, logos, shapes, and patterns, may also apply to the imagery that appears inside the hologram image. The software that handles the representation of the logo is also combined with SRRM redemption technology (described in further detail herein), such that wireless communications and other authentication measures are wedded with SRRM as a whole to create a combined authentication/security measure whose strength and difficulty to circumvent, as a whole, is greater than the sum of its parts.

The system of the invention may include the following features referred to as “Gamesmanship” features that are intended to promote adoption of the platform, frequent use/traffic of the platform, increased interaction with the platform, increased information/functionality/features of the platform, and enhanced entertainment value to some users of the platform, among other things.

Gamesmanship features may relate to collecting points to win titles and accolades. The user gains points of many various kinds, which can via formulae translate into any number of various titles and accolades. For example, one accolade or title could be like Foursquare stood on its head: instead of being mayor for simply going to the same place more often than anyone else, there may be points assigned each time the user checks into a place he has not been before. The user who wins this contest gains a title such as “Man of the World”. Innumerable “gamesmanship competitions” can be created on the fly by inputting any number of the various points into a new formula and assigning the competition a title/accolade: Who travels the most, who goes to the most venues, who has cooler friends (who score higher at doing the above), who sets trends by going to events that got higher ratings, etc.

As introduced above, gamesmanship may relate to acquiring points in different categories: points for checking in to a venue (that is, using the platform's SocialNet functions to report that a user is there); points for checking someone else in to a venue (a SocialNet friend on the platform, for instance); points for a user providing more TasteTrak information about herself; points for whenever other users swap in or download the user's TasteTrak profile or elements thereof; points for attending highly rated events; points for attending events from genres a user has not yet attended; points for enlisting more friends into joining the system; points for throwing private events which are posted on the platform; points for entering event information into the system; points for invitations; points for tapping on banners; points for specifying to TasteTrak which kinds of vendors/sponsors they like/dislike; points for transacting via Slide-to-Buy either event tickets or products/services with sponsors/vendors; points for using DICs; points for creating new TasteTrak vector components (a “quality” or “characteristic” in the TasteTrak event profiling vector for which any event, artist, event genre, or venue contains information such as fuzzy membership values); points for users voluntarily supplying information about how events, artists, venues, and event genres match various TasteTrak event vector components; points for having used the platform at least once within a certain time block (hour, day, week, month, year, lifetime); points for using certain widgets within the system; points for each feature in the system that has been used beyond a certain threshold number of times; points for the user having text-, photo-, or video-blogged events, venues, artists; points for number of times others invite you to events; points for number of times others in your SocialNet message you or view your profile/status; points for content provision (the user supplying photos of artists, venues, and events to the system); points for rating an event, artist, or venue; points for contests in which you must elicit votes from other users (such as “coolest”, “most gorgeous”, “best dancer”), and so on. Gamesmanship titles and accolades, such as “King/Queen of Cool”, “Most Popular”, “Recruitment Crown”, and so on, are separate isolated algorithms which selectively weigh certain kinds of points together in a formula that appropriately quantifies the particular gamesmanship accolade. For example, the winner of the title “Recruitment Crown” could be driven by a formula such as: 10*(points from direct enlistments into the system)+(points from number of direct enlistments into the system by your own direct enlistments)/10, whereas “Queen of New York” could be awarded to the female in the system whose usage of the system in New York City scored highest by a formula that added together points from recruitments; points from event attendance; points from number of friends; points from number of times her TasteTrak profile has been downloaded or sampled by others, number of highly rated events attended, etc; and/or points corresponding to other information.

Gamesmanship features may relate to team play/group creation. Friends who are collectively cool become a group entity that can name themselves and they collectively gain points together like a team for these categories.

Gamesmanship features may relate to gamesmanship taken to a real level, unlike games which reward undesirable behaviors or virtual life over real life. To win the user is simply scored on having a more rewarding real social life, with Dibbs' various titles and accolade competition formulae cluing the user in on how to do it. For instance, the “Duke of where it's at” may be whoever has gone to more venues and events than anyone else, which received a three star or above rating, with two star and one star events subtracting points from their score.

Gamesmanship features may relate to scavenger hunt style gamesmanship. For example, if the user hasn't gone to a wine tasting or festival, going to one of these for the first time will help the user's rating out more. The “game” shows the user the user's score/status rating and how to gain more coolness/status by getting out more and having a broader education into all aspects of a rewarding social life. According to some implementations, if a user selects to enter a competition for a title or accolade, the system can flag events in their list that will help them gain points, and/or send alerts to their social inbox, email, etc., for events that will assist them in gaining a higher score, and/or access the competition through a widget which shows the participants, leaders, and/or pertinent events that may help them score higher in the competition.

Gamesmanship features may relate to social pull or magnet points. The more people come to an event because the user is there, the more magnet points and status points the user get. Hosting a private event (party) gets the user more points the more cool people come to it, thereby incentivizing people to have more of a social life and throw more events and parties for each other.

Gamesmanship features may relate to “arbitrary seeming correlational data.” This adds an element of entertainment to the collection of TasteClues. Specifically, the seemingly arbitrary and irrelevant questions like “Does the user prefer coke or pepsi?” and the like, which never the less form fact clusters that provide correlations and recognized patterns, fuzzy membership in other informational categories, etc., that point the way to metapatterns of taste information about the user. This type of “Gamesmanship” isn't limited to just “arbitrary seeming” questions, but to all questions that TasteTrak may ask.

In some implementations, Gamesmanship goes like this: after answering every nth question (e.g., every 5th or 8th or nth question), the TasteTrak system will tell the user some factoid about others who answer similarly to the user. Like, “Did the user know, that 94% of the people who answered the same way as the user to the last five questions, categorized themselves politically as moderates?” This adds a fun element that incentivizes the collection of user data, and demonstrates the correlational power of the TasteTrak system. At any point in the sequence of questions, the user has the opportunity to opt out of more questions (for now), or to continue answering them. Within the system, there is a feature to go answer more questions at any time, as well. Finally, there is a feature or setting in the system for only asking the questions every nth time the user launches the service. Optionally, this setting can also be a user preference where the user is allowed more direct control over how often he/she is asked TasteTrak questions on launch of the application or web page.

Success at any or all of the various Gamesmanship initiatives may award the user with “Dibbs Dollars.” Signing new users up may result in more “Social Pull or Magnet points”, and/or “Dibbs Dollars”.

According to some implementations, the system referred to herein as the Widget EcoSystem and described below may also be provided by the invention. The Widget Ecosystem is a collection of “apps within the app” or “services within The Service”. Each Widget is an individual software program, or compartmentalized routine within the app, that meets certain criteria. Widgets may be submitted for addition to the platform by third party creators, or added to the platform by the Company itself or its partners. It must supply a graphical icon and name, representing its unique service. It must be programmed in such a way to meet certain criteria that allow it to “inhabit” the platform as a whole. Optionally, it must be approved by the host of the platform. Optionally, it must provide a certain percentage of its revenues in the form of royalties, to the host of the platform, or an alternative arrangement in which the host is able to collect a fee for enabling the possibility that the widget app can be hosted. Optionally, users can select, install, reorder, and delete widgets in the user interface of the platform.

The widget may use existing APIs in the platform. The platform provides and offers up many, most, or all of its internal API functions to any widget that resides on the system. For example, fetching event data from EventScout, or specials data from the LIP Service, are services internal to the platform that “guest widgets” approved for hosting on the platform, may also use. This enables rapid writing and deployment of all manner and types of recombinations of the core services of the Dibbs Platform (i.e., all manner of recombination of EventScout, TasteTrak, SocialNet, etc.).

Whatever unique service or services a Widget provides, in some implementations must become offered up as part of the “hive” or collective of other APIs that other widgets may use. This “collective hive” includes internal APIs of the Dibbs Platform, as well as other APIs of all widgets apps that were subsequently added thereto. This creates an ever-growing “Widget SDK” that allows widget developers to create ever more powerful functions, features, and services. It harnesses all the collective power of open source/open platform architectures, yet all the security, quality control, and reward incentive of free market competitive ventures performed to provide superior service in order to acquire profit. To protect third party developers, new widget apps may not be approved if they are substantially identical to an existing widget and merely steal and repackage its API.

To exemplify a possible widget, there may be a widget which takes information about golf courses and tee times from internet sources. It then repackages these tee times as “events” in a private “EventScout” style database, by using the pre-existing API for such that the Platform provides. A little extra programming provides a user interface for selecting from various golf courses, reading and making reviews, seeing and providing content such as photo and video, etc., and letting the user select. The user may then purchase entry/position at a tee time using the Tap-and-Go interface also provided by the API, and a Digital Interactive Ticket to do such, also provided by the API. In short, a fully functional, complete, sophisticated, feature-rich, best-in-class golf course tee time finder, surfer, and reservation tool that would take several years worth of work, could be developed with minimal effort by harnessing the existing Ecosystem API. The minute the Widget is completed, the functions/information/service it provides “joins” the hive collective API, so that others may then think of new ways to further the system, perhaps adding social networking features, or finding which friends are at which golf courses, or whatever.

The Virtual Currency or “Dibbs Dollars” which are mentioned above have various features in accordance with the invention that are described below. Virtual currency or “Dibbs Dollars” are not actual currency, but represent “points” or “credits” that may be redeemed in various ways to achieve partial or full discounts on various items. These various items may include (but are not limited to), tickets, merchandise, commercial banners, “social banners”, and discounts/offers at participating Dibbs venues and vendors.

Ways in which users may obtain Dibbs Dollars may include (but are not limited to): getting points each time Dibbs is launched, signing up new users, visiting a Dibbs venue/vendor in a way where Dibbs is used at the venue/vendor (e.g., using a DIC or DIT), clicking on a banner, answering TasteTrak questions, getting a venue or vendor onboard the Dibbs network or affiliated in some action in the Dibbs LAMP (local area marketing program), creating a lead or introduction to any of the above (venue,vendor,artist,etc.), getting an artist to become a Dibbs artist affiliate, posting an event that passes quality control and is accepted into the Dibbs system as a published event, providing video/photo content to Dibbs, using Dibbs' social networking features, posting about Dibbs on Facebook or other social networks and using Dibbs to do such, any social messaging that mentions Dibbs (including but not limited to, automatically canned messages that the user may opt into sending such as “I just joined Dibbs, the world's premier events and entertainment service”, “I just got into the XYZ club without waiting in line using a Dibbs Digital Interactive Ticket”, “I just used a Digital Interactive Coupon right from my phone to get a good deal at venue XYZ, using the Dibbs app on my phone!”, and so on.

Dibbs Dollars/Points and/or other virtual currency may be combined with gamesmanship on the Dibbs platform. Dibbs Dollars/Points may be redeemable with Dibbs sponsors, not as actual dollar credits, but as credits toward a discount up to a certain percentage that the sponsor is willing to surrender promotionally in order to generate more business, regardless.

The following describes some of the content provision features on the Dibbs Platform constructed in accordance with the invention. Content is a key part of the Dibbs Platform, according to some implementations. The notion is that a picture is worth a thousand words, and a video is worth a thousand pictures. Users are far more attracted by rich media content, than they are by simple text. Therefore, Dibbs is beginning to implement a strategy to try to maximize any and every way that the platform is enhanced via rich media.

The Dibbs Platform may be configured to allow users to take their own videos of artists, events, and venues, and post it up to Dibbs. In some implementations, users may surrender IP rights to the content to Dibbs. Videos of artists, events, and venues are accessible through the main platform whenever viewing information on a particular artist, venue, or event. Tapping through on an artist, venue, or event, makes immediately accessible a gallery of photos and videos that users have shared. Users can rank/rate the videos/photos others have posted, which earns them Dibbs Points for doing, and earns Dibbs Points for those who have posted based on the rating they receive. Videos/photos of artists/events/venues automatically get prioritized higher or deleted, based on the ratings/rankings received, as an automatic quality control mechanism of content within the system. Inappropriate content can be flagged as objectionable in which case it flags a human follow up where if found inappropriate, a user's rights to post content can be revoked. In some implementations, venues and/or artists can provide video and/or photos in the same manner as users.

E-commerce features of the Dibbs platform constructed in accordance with the invention include some features relating to tap-inputted commands. It is noteworthy that the following examples are illustrative and are not intended to be limiting as other commands and/or input techniques fall within the scope of the present invention. In one example, “tap to buy” may allow the user to immediately buy through the user's Dibbs account and have the special deal delivered. Tap to buy may allow the user to buy the physical item(s) of the special deal, straight through the user's Dibbs account. Tap to buy on third-party sites (e.g., Amazon) may allow the user to buy through a secondary distribution channel. The user may purchase through information already present on the user's Dibbs account, then have the order fulfilled through the fulfillment channel. Some things that differentiate one or more implementations from other systems is the use of a touch screen interface, optionally using native application UI and programming rather than much more limited HTML-based UI controls, and the fact that this systems creates a third party gateway where users can purchase from multiple vendors through a consistent, trusted, uniform intermediate entity who then allocates funds to the vendor based on the terms of an order fulfillment revenue contract and model already in place. Tap to video may allow the user to see a video promoting the sponsor and/or his deal right on the device and may include multiple video slots (videos can promote a venue, an event, a sale/special, etc.). Tap to visit may allow the user to visit a website of sponsor. Tap to download may allow the user to download an application and/or other information. Tap to interactive video (flash/html 5 style) video+UI may provide an interactive video that has user interface functions that allow selections, interactivity, etc. Tap to call may allow the user to call the sponsor. Tap to map/find nearest location may allow the user to see a map to the nearest sponsor location from the user's current GPS location. Tap for punch card special may provide a special such as those used at coffee houses, buy 10 get 1 free, etc. Tap for coupon specials may allow the user to reduce and/or eliminate imagery space in the ILS occupied by a coupon, other information instead of a coupon, and/or multiple coupons or specials offered. Tap to see calendar/events may allow the user to see, for venues or other sponsors, one or more upcoming calendar of events, specials, etc. Tap to opt in (e.g., specials etc.) may allow the user to sign up for specials (via, e.g., email, Dibbit Alerts, etc.) from a particular sponsor. Tap to socially network may allow the user to become “friended” with this sponsor via Dibbs SocialNet, Facebook, etc.; deliver a virtual gift to friend; pass an opportunity on to an interested friend; and/or perform other actions associated with a social network.

E-commerce features of the Dibbs platform constructed in accordance with the invention include some features relating to slide-inputted and finger gesture commands. It is noteworthy that the following examples are illustrative and are not intended to be limiting as other commands and/or input techniques fall within the scope of the present invention. “Slide to buy” may include a multimedia interactive experience upon the purchase of an item. The transaction is executed by sliding a virtual button or other graphic across a touch screen with the finger or fingers. In some implementations, responsive thereto are vibration, sounds, colors, animation, or any other real-time visual, touch, or sound effects that increase or alter the closer the user gets to fully sliding and executing the transaction. Animations may accompany the sliding experience, and sound. In some implementations, animations send little beads or visual “energy fields” in the direction to be slided, enticing the user to slide. A vibration that happens when the user is done sliding may occur, or it may get “ecstatic” as the slide is about to finish. Slide-to-redeem for tickets and coupons is part of the slide-to-buy IP as well.

In some implementations, the Mobile Interactive Ticket features ultra-convenient purchase technology which enables the user to purchase the ticket with an absolute minimum of user interaction. (One incarnation of this technology has been named “Slide-to-Buy”. This name will be used herein as a convenient name to reference all incarnations of the technology, not merely the Slide-to-Buy incarnation.) By keeping payment information on account, such as how the credit card is stored and accessed above, or other systems which create similar functional results, using a device with a touch screen display, and programmatically creating user interlace elements which allow for unique and unmistakably intentional finger interactions, a scenario is created wherein the user need only interact his intent to purchase a ticket, product, or service, and then be displayed a screen that enables the execution of the purchase with finger gesture(s) performed upon the device's touch sensitive input display. Whereas the clicking of a button might be one way to do this, it may have the disadvantage of allowing for the possibility of unintentional purchases. On account billing methods and billing information, such that a user does not have to fill out billing information (such as credit cards, paypal, etc.) each time he makes a purchase, because this information is already securely stored and accessible at the time the user decides to close a purchase.

Touch screen sensitive displays that allow users to input their desired intent through interaction between their fingers and user controls on the screen. The ability to, through special software, programmatically create and/or utilize user interface controls that greatly reduce or eliminate the possibility of an unintentional purchase. Unintentional interactions typically feature a finger or fingers accidentally pressing on a certain part of the touch screen display's surface, which may have a button that is then unintentionally activated, such as the well-known example of “pocket dialing.” To ensure that the interaction is an intentional desire to close a purchase, the programmatically designed user interface requires the user to perform certain finger gestures that are highly unlikely to come about unintentionally. For example, in one implementation, the user interacts with a programmatic control called “slide-to-buy”, in which the finger must touch a small round graphically represented slider, then carefully drag it along inside a graphical track or rail. If the finger ever exits the confines of the rail before completing its journey to the end of the rail, the slider control resets to its original starting position and the purchase is not made. Otherwise, if the finger successfully completes its journey from start to finish along the rail, it is considered a secure and definitive proof of the user's actual intention to close the purchase, which is then closed via conventional information technology solutions. Other implementations may include aligning, dragging, or positioning certain elements to be next to each other, or pushing buttons in a certain order, or performing a gesture that fulfills the outline of a certain symbol or shape (such as a check mark), or tapping on each corner of a shape (possibly in a certain sequence), and in general, any gesture that is convenient to perform but highly unlikely to ever come about unintentionally.

Slide-to-Buy purchase technology has no limitations which restrict it only to the purchase of a Digital Interactive Ticket. Slide-to-Buy technology can be implemented in any other mobile device based commerce, wherein users have the opportunity to make purchases via their devices. This includes mobile websites, as accessed via mobile devices with touch screen displays; regular websites when accessed through conventional computers which feature touch screen displays (many conventionally sized non-mobile computers now feature monitors with touch screen displays and operating systems and drivers are becoming more prominent for allowing touch screen input in a conventional desktop computing environment); promotional purchase offers originating from Mobile Interactive Promotion (described herein) fulfillment technologies similar to Mobile Interactive Promotion, wherein commerce opportunities are displayed via a custom user interface on a mobile device with touch screen display; and any other digital commerce opportunity where the user is displayed a programmatically created user interface on a touch screen display, thereby giving the opportunity for incorporating all the elements of Slide-to-Buy or similar finger gesture based solutions for ultra-convenient purchase closure.

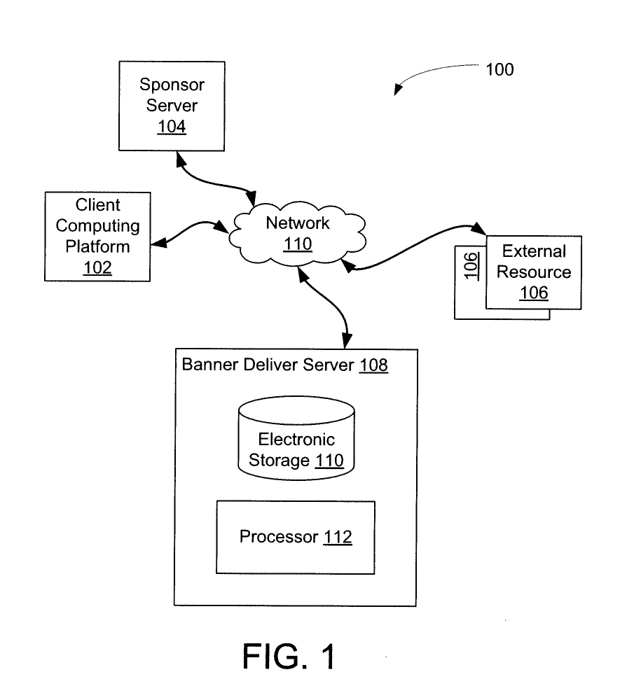

Referring now to the figures, FIG. 1 illustrates a system 100 configured to provide regionally-tiered Internet banner delivery, in accordance with one or more implementations. The system 100 may implement one or more features described herein. For example, the system 100 may include one or more features associated with the Dibbs platform and/or other features. As depicted, the system 100 may include at least one client computing platform 102, at least one sponsor server 104, one or more external resources 106, at least one banner delivery server 108, and/or other components, all being communicatively coupled to a network 110.

The network 110 may include the Internet and/or other networks. It will be appreciated that this is not intended to be limiting, and that the scope of this disclosure includes implementations in which the client computing platform 102, the sponsor server 104, the external resources 106, the banner delivery server 108, and/or other components are operatively linked via some other communication media.

The client computing platform 102 may include one or more processors configured to execute computer program modules. The computer program modules may be configured to enable one or more users associated with the client computing platform 102 to interface with the system 100, the sponsor server 104, the external resources 106, the banner delivery server 108, and/or other components, and/or provide other functionality attributed herein to the client computing platform 102. By way of non-limiting example, the client computing platform 102 may include one or more of a desktop computer, a laptop computer, a handheld computer, a NetBook, a Smartphone, and/or other computing platforms. As such, the client computing platform 102 may include one or more user interface devices. Examples of such user interface devices include a screen, a touch pad, a touch screen, a keyboard, a keypad, and/or other user interface devices suitable to facilitate interactions and/or information transfer between the client computing platform 102 and a user.

The sponsor server 104 may be configured to provide one or more banners. A given banner may be associated with a given sponsor. Individual ones of the one or more banners may be configured to present media content. Media content may include still images, video, audio, and/or other media content. Individual ones of the one or more banners may be associated with other features described herein. The sponsor server 104 may include one or more processors configured to execute computer program modules, electronic storage, and/or other components.

The external resources 106 may include sources of information, hosts and/or providers of web sites and/or services outside of the system 100, external entities participating with the system 100, and/or other resources. In some implementations, the external resources 106 may include social networking web sites, content providers, and/or other resources. Some or all of the functionality attributed herein to the external resources 106 may be provided by resources included in the system 100.

The banner delivery server 108 may be configured to provide regionally-tiered internet banner delivery. The banner delivery server 108 may include electronic storage 110, at least one processor 112, and/or other components.

The electronic storage 110 may comprise electronic storage media that electronically stores information. The electronic storage media of the electronic storage 110 may include one or both of system storage that is provided integrally (i.e., substantially non-removable) with the banner delivery server 108 and/or removable storage that is removably connectable to the banner delivery server 108 via, for example, a port (e.g., a USB port, a firewire port, etc.) or a drive (e.g., a disk drive, etc.). The electronic storage 110 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage 110 may store software algorithms, information determined by processor 112, information received from the client computing platform 102, the sponsor server 104, the external resources 106, information associated with features described herein, and/or other information that enables the banner delivery server 108 to function as described herein.

The processor(s) 112 may be configured to provide information processing capabilities in the banner delivery server 108. As such, the processor 112 may include one or more of a digital processor, an analog processor, a digital circuit designed to process information, an analog circuit designed to process information, a state machine, and/or other mechanisms for electronically processing information. Although the processor 112 is shown in FIG. 1 as a single entity, this is for illustrative purposes only. In some implementations, the processor 112 may include a plurality of processing units. These processing units may be physically located within the same device, or the processor 112 may represent processing functionality of a plurality of devices operating in coordination.

As is shown in FIG. 1, the processor 112 may be configured to execute one or more computer program modules and/or instructions. The processor 112 may be configured to execute the computer program modules and/or instructions by software; hardware; firmware; some combination of software, hardware, and/or firmware; and/or other mechanisms for configuring processing capabilities on the processor 112. The computer program modules and/or instructions may be executed to cause the processor 112 to perform methods and/or effectuate features described herein.

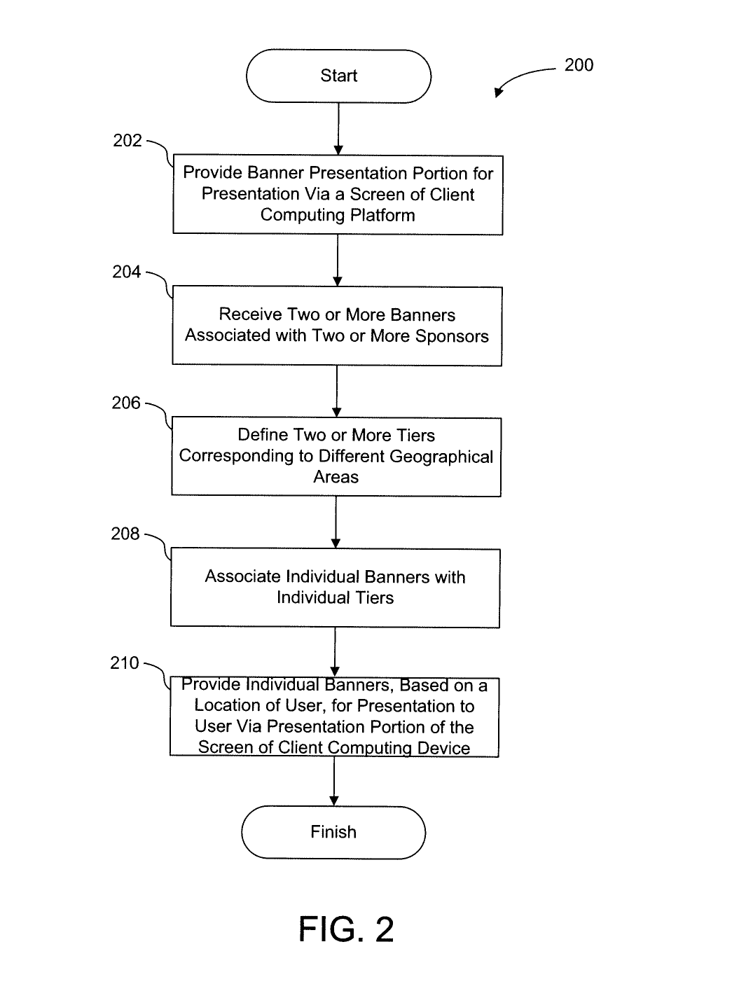

FIG. 2 is a flowchart illustrating a method 200 for providing regionally-tiered internet banner delivery, in accordance with one or more implementations. The operations of the method 200 presented below are intended to be illustrative. In some implementations, the method 200 may be accomplished with one or more additional operations not described, and/or without one or more of the operations discussed. Additionally, the order in which the operations of the method 200 are illustrated in FIG. 2 and described below is not intended to be limiting.

In some implementations, the method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of the method 200 in response to instructions stored electronically on an electronic storage medium. The one or more processing devices may include one or more devices configured through hardware, firmware, and/or software to be specifically designed for execution of one or more of the operations of the method 200.

At operation 202, a banner presentation portion may be provided for presentation to a user via a screen of a client computing platform (e.g., the client computing platform 102). The banner presentation portion may be configured to present one or more banners. Operation 202 may be performed by the banner delivery server 108 and/or other components of the system 100.

At operation 204, two or more banners associated with two or more sponsors may be received. Individual ones of the two or more banners may be configured to present media content. The two or more banners may be received from the sponsor server 104, the external resources 106, and/or other components of the system 100. Operation 204 may be performed by the banner delivery server 108 and/or other components of the system 100.

At operation 206, two or more tiers may be defined, which include a first tier and a second tier. Individual ones of the two or more tiers may correspond to different geographical areas. The geographical areas may be overlapped and/or non-overlapped. The first tier may correspond to a larger geographical area than the second tier. Operation 206 may be performed by the banner delivery server 108 and/or other components of the system 100.

At operation 208, individual ones of the two or more banners may be associated with individual ones of the two or more tiers. A given banner may be associated with a given tier based on a desired geographical area to which the given banner is directed. Operation 208 may be performed by the banner delivery server 108 and/or other components of the system 100.

At operation 210, individual ones of the two or more banners may be provided, based on a location of the user, for presentation to the user via the presentation portion of the screen of the client computing device. Operation 210 may be performed by the banner delivery server 108 and/or other components of the system 100.

Although the invention has been described in detail for the purpose of illustration based on what is currently considered to be the most practical and preferred implementations, it is to be understood that such detail is solely for that purpose and that the invention is not limited to the disclosed implementations, but, on the contrary, is intended to cover modifications and equivalent arrangements that are within the spirit and scope of the appended claims. For example, it is to be understood that the present invention contemplates that, to the extent possible, one or more features of any implementation can be combined with one or more features of any other implementation.

What is claimed is:

1. A method for providing regionally-tiered internet banner delivery, the method comprising:
providing, for presentation to a user via a screen of a client computing platform, a banner presentation portion, the banner presentation portion being configured to present one or more banners;
receiving two or more banners associated with two or more sponsors, individual ones of the two or more banners being configured to present media content;
defining two or more tiers including a first tier and a second tier, individual ones of the two or more tiers corresponding to different geographical areas, the geographical areas being overlapped and/or non-overlapped, the first tier corresponding to a larger geographical area than the second tier;
associating individual ones of the two or more banners with individual ones of the two or more tiers, a given banner being associated with a given tier based on a desired geographical area to which the given banner is directed; and
providing, for presentation to the user via the presentation portion of the screen of the client computing device, individual ones of the two or more banners based on a location of the user.

2. The method of claim 1, wherein one or more dimensions of the banner presentation portion are based on dimensions defined by a given sponsor associated with a given banner being presented by the banner presentation portion.

3. The method of claim 1, wherein the first banner to be provided for presentation to the user is randomly determined from among the individual ones of the two or more banners or is determined according to a premium paid by a given sponsor.

4. The method of claim 1, wherein the two or more tiers include one or more of a global tier, a continental tier, a national tier, a sub-national tier, a regional tier, a metropolitan tier, a city tier, or a neighborhood tier.

5. The method of claim 1, wherein the two or more tiers include a GPS radial tier, the GPS radial tier being defined by an area encompassing the client computing device.

6. The method of claim 1, wherein the two or more tiers are included in a queue of tiers, and wherein banners associated with a given tier are included in a queue of banners.

7. The method of claim 6, wherein a sequence in which the individual ones of the two or more banners are provided for presentation to the user is based on a series of operations, the series of operations including:
(1) from the queue of tiers, a first tier is selected;
(2) from the first tier, a first banner is selected from the corresponding queue of banners;
(3) the first banner is provided for presentation to the user;
(4) the selected banner is placed at the end of the queue of banners corresponding to the first tier;
(5) from the queue of tiers, a next tier following the first tier is selected;
(6) from the next tier, a second banner is selected from the corresponding queue of banners;
(7) the second banner is provided for presentation to the user; and
(8) the second banner is placed at the end of the queue of banners corresponding to the next tier.

8. The method of claim 1, wherein a sequence in which the individual ones of the two or more banners are provided for presentation to the user is based on one or more of factual intelligence on the user's music collection, collected real-time usage data intelligence on actions taken by the user, or social network intelligence associated with the user.

9. A system configured to provide regionally-tiered internet banner delivery, the system comprising:
one or more processors configured to execute one or more computer program modules, execution of the one or more computer program modules causing the one or more processors to:
provide, for presentation to a user via a screen of a client computing platform, a banner presentation portion, the banner presentation portion being configured to present one or more banners;
receive two or more banners associated with two or more sponsors, individual ones of the two or more banners being configured to present media content;
define two or more tiers including a first tier and a second tier, individual ones of the two or more tiers corresponding to different geographical areas, the geographical areas being overlapped and/or non-overlapped, the first tier corresponding to a larger geographical area than the second tier;
associate individual ones of the two or more banners with individual ones of the two or more tiers, a given banner being associated with a given tier based on a desired geographical area to which the given banner is directed; and
provide, for presentation to the user via the presentation portion of the screen of the client computing device, individual ones of the two or more banners based on a location of the user.

10. The system of claim 9, wherein one or more dimensions of the banner presentation portion are based on dimensions defined by a given sponsor associated with a given banner being presented by the banner presentation portion.

11. The system of claim 9, wherein the first banner to be provided for presentation to the user is randomly determined from among the individual ones of the two or more banners or is determined according to a premium paid by a given sponsor.

12. The system of claim 9, wherein the two or more tiers include one or more of a global tier, a continental tier, a national tier, a sub-national tier, a regional tier, a metropolitan tier, a city tier, or a neighborhood tier.

13. The system of claim 9, wherein the two or more tiers include a GPS radial tier, the GPS radial tier being defined by an area encompassing the client computing device.

14. The system of claim 9, wherein the two or more tiers are included in a queue of tiers, and wherein banners associated with a given tier are included in a queue of banners.

15. The system of claim 14, wherein a sequence in which the individual ones of the two or more banners are provided for presentation to the user is based on a series of operations, the series of operations including:
(1) from the queue of tiers, a first tier is selected;
(2) from the first tier, a first banner is selected from the corresponding queue of banners;
(3) the first banner is provided for presentation to the user;
(4) the selected banner is placed at the end of the queue of banners corresponding to the first tier;
(5) from the queue of tiers, a next tier following the first tier is selected;
(6) from the next tier, a second banner is selected from the corresponding queue of banners;
(7) the second banner is provided for presentation to the user; and
(8) the second banner is placed at the end of the queue of banners corresponding to the next tier.

16. The system of claim 9, wherein a sequence in which the individual ones of the two or more banners are provided for presentation to the user is based on one or more of factual intelligence on the user's music collection, collected real-time usage data intelligence on actions taken by the user, or social network intelligence associated with the user.

17. A computer-readable storage medium having instructions embodied thereon, the instructions being executable by one or more processors to perform a method for providing regionally-tiered Internet banner delivery, the method comprising:
providing, for presentation to a user via a screen of a client computing platform, a banner presentation portion, the banner presentation portion being configured to present one or more banners;
receiving two or more banners associated with two or more sponsors, individual ones of the two or more banners being configured to present media content;
defining two or more tiers including a first tier and a second tier, individual ones of the two or more tiers corresponding to different geographical areas, the geographical areas being overlapped and/or non-overlapped, the first tier corresponding to a larger geographical area than the second tier;
associating individual ones of the two or more banners with individual ones of the two or more tiers, a given banner being associated with a given tier based on a desired geographical area to which the given banner is directed; and
providing, for presentation to the user via the presentation portion of the screen of the client computing device, individual ones of the two or more banners based on a location of the user.

18. The computer-readable storage medium of claim 17, wherein one or more dimensions of the banner presentation portion are based on dimensions defined by a given sponsor associated with a given banner being presented by the banner presentation portion.

19. The computer-readable storage medium of claim 17, wherein the first banner to be provided for presentation to the user is randomly determined from among the individual ones of the two or more banners or is determined according to a premium paid by a given sponsor.

20. The computer-readable storage medium of claim 17, wherein the two or more tiers include one or more of a global tier, a continental tier, a national tier, a sub-national tier, a regional tier, a metropolitan tier, a city tier, or a neighborhood tier.

21. The computer-readable storage medium of claim 17, wherein the two or more tiers include a GPS radial tier, the GPS radial tier being defined by an area encompassing the client computing device.

22. The computer-readable storage medium of claim 17, wherein the two or more tiers are included in a queue of tiers, and wherein banners associated with a given tier are included in a queue of banners.

23. The computer-readable storage medium of claim 22, wherein a sequence in which the individual ones of the two or more banners are provided for presentation to the user is based on a series of operations, the series of operations including:
(1) from the queue of tiers, a first tier is selected;
(2) from the first tier, a first banner is selected from the corresponding queue of banners;
(3) the first banner is provided for presentation to the user;
(4) the selected banner is placed at the end of the queue of banners corresponding to the first tier;
(5) from the queue of tiers, a next tier following the first tier is selected;
(6) from the next tier, a second banner is selected from the corresponding queue of banners;
(7) the second banner is provided for presentation to the user; and
(8) the second banner is placed at the end of the queue of banners corresponding to the next tier.

24. The computer-readable storage medium of claim 17, wherein a sequence in which the individual ones of the two or more banners are provided for presentation to the user is based on one or more of factual intelligence on the user's music collection, collected real-time usage data intelligence on actions taken by the user, or social network intelligence associated with the user.
